(19) United States
(12) Patent Application Publication
(10) Pub. No.: US 2025/0385751 A1
(43) Pub. Date: Dec. 18, 2025

(54) PROCEDURES OF ENHANCED MODE CHANGE IN WIFI SYSTEM

(71) Applicant: InterDigital Patent Holdings, Inc., Wilmington, DE (US)

(72) Inventors: Hanqing LOU, Melville, NY (US); Mahmoud SAAD, Montreal (CA); Xiaofei WANG, North Caldwell, NY (US)

(21) Appl. No.: 18/743,483

(22) Filed: Jun. 14, 2024

(51) Int. Cl. H04L 1/00; H04W 52/02

(52) U.S. Cl. CPC H04L 1/0025; H04L 1/0068; H04W 52/0235

(57) ABSTRACT

Methods and structures are disclosed that permit a station (STA) operating in a WIFI network to initiate a dynamic operating mode change between a pair of STAs in which the mode change may be transient and the STAs may change back to an original mode after the end of a transmission operation (TXOP), after a certain time defined in mode change parameters/frames and/or after certain one or more criteria are met.

### BACKGROUND

Operating Mode Indication (OMI) in Wireless Fidelity (WiFi) networks is a concept that allows for more dynamic communication between WiFi clients/devices/stations (STAs) and Access Points (APs) connected to a WiFi network, more recently in the context of 802.11ax (WiFi 6). OMI is a mechanism for a WiFi STA to indicate changes in its operation mode or to inform the AP about its capabilities. This allows for more efficient use of network resources and improved performance.

### SUMMARY

An advance in the art may be realized by aspects of the embodiments disclosed herein.

In certain aspects, embodiments of a method are disclosed for a station (STA), the method comprising: the STA initiating a dynamic operating mode change between a pair of STAs in which the mode change may be transient and the STAs may change back to an original mode after the end of a transmission operation (TXOP), after a certain time defined in mode change parameters/frames and/or after certain one or more criteria are met.

Finally, in certain aspects, embodiments of a method are disclosed in which new frame elements are used to initiate the dynamic operating mode change between a pair of STAs in which the mode change may be transient and the STAs may change back to an original mode after the end of the TXOP, after a certain time defined in the new frame elements and/or after certain one or more criteria are met. Additional aspects are also disclosed.

One or more embodiments also provide a computer program comprising instructions which when executed by one or more processors cause the one or more processors to perform the methods according to any of the embodiments described herein.

### BRIEF DESCRIPTION OF THE DRAWING

A more detailed understanding may be had from the following description, given by way of example in conjunction with the accompanying drawing, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an illustrative embodiment of a dynamic operating-mode change (DMC) in a WiFi network according to aspects of the present disclosure;

FIG. 3 shows an illustrative format of an Aggregated Control (A-Control) subfield of an HE variant HT Control field according to aspects of the present disclosure;

FIG. 4 shows an illustrative format of each Control subfield of an HE variant HT Control field according to aspects of the present disclosure;

FIG. 5 shows an illustrative Class 1 dynamic mode change of Mode 1 to transient Mode 2 and return to Mode 1 in which an Initial Control Frame (ICF) is transmitted using Mode 1 and an Initial Control Response (ICR) is transmitted using Mode 2, according to aspects of the present disclosure;

FIG. 6 shows an illustrative Class 2 dynamic mode change of Mode 1 to transient Mode 2 and return to Mode 1 in which an Initial Control Frame (ICF) and an Initial Control Response (ICR) are transmitted using Mode 1 before mode change, according to aspects of the present disclosure;

FIG. 7 shows an illustrative Class 3 dynamic mode change of Mode 1 to transient Mode 2 and return to Mode 1 in which an Initial Control Frame (ICF) an Initial Control Response (ICR) are transmitted using Mode 2, according to aspects of the present disclosure;

FIG. 8 shows illustrative ICF design considerations when the ICF is initiated by an AP according to aspects of the present disclosure;

FIG. 9 shows illustrative ICR design considerations when the ICR is initiated by an AP according to aspects of the present disclosure;

FIG. 10 shows illustrative ICF design considerations when the ICF is initiated by a non-AP STA according to aspects of the present disclosure;

FIG. 11 shows illustrative ICR design considerations when the ICF is initiated by a non-AP STA according to aspects of the present disclosure; and

FIG. 12 shows illustrative exemplary procedure of using ICF/ICR to allow dynamic preamble puncturing according to aspects of the present disclosure.

### DETAILED DESCRIPTION

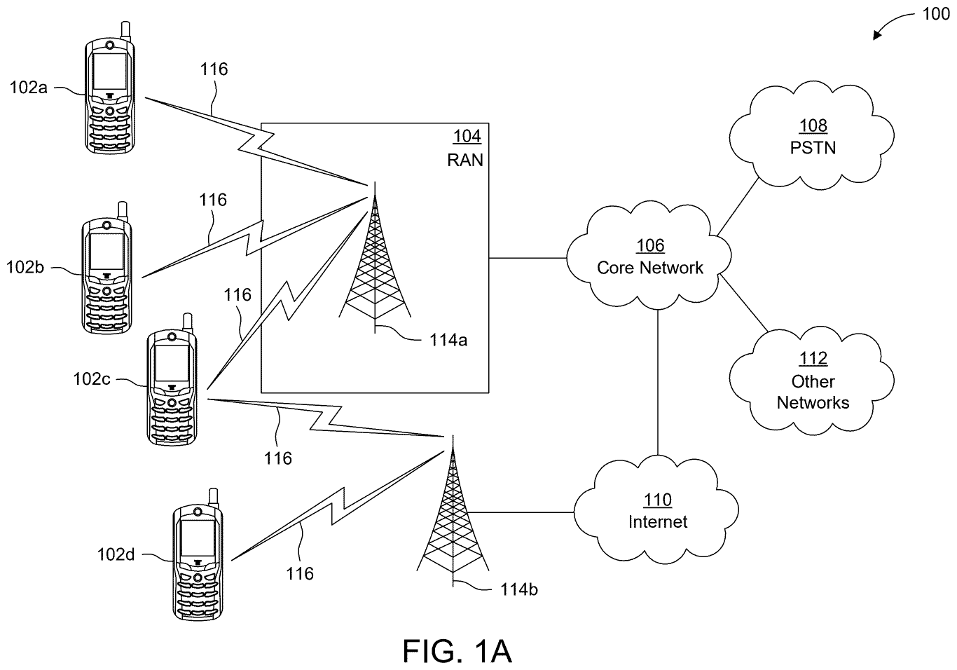

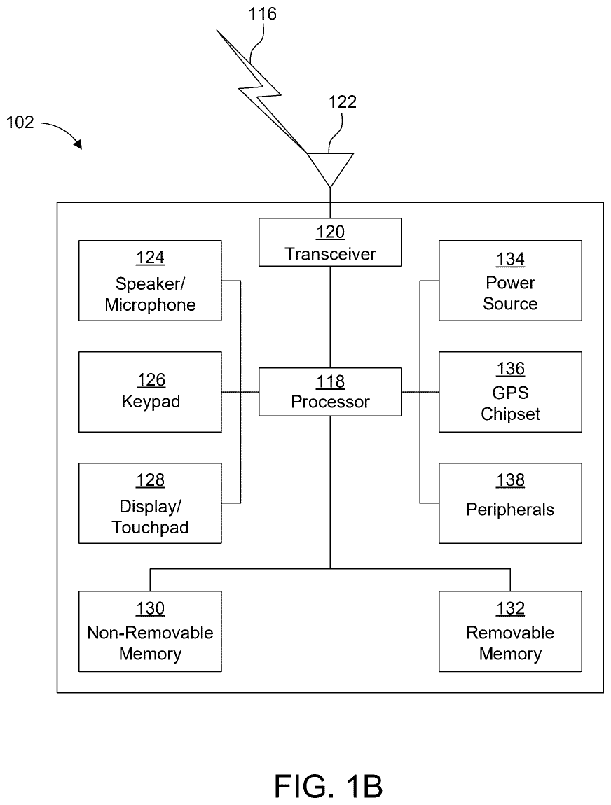

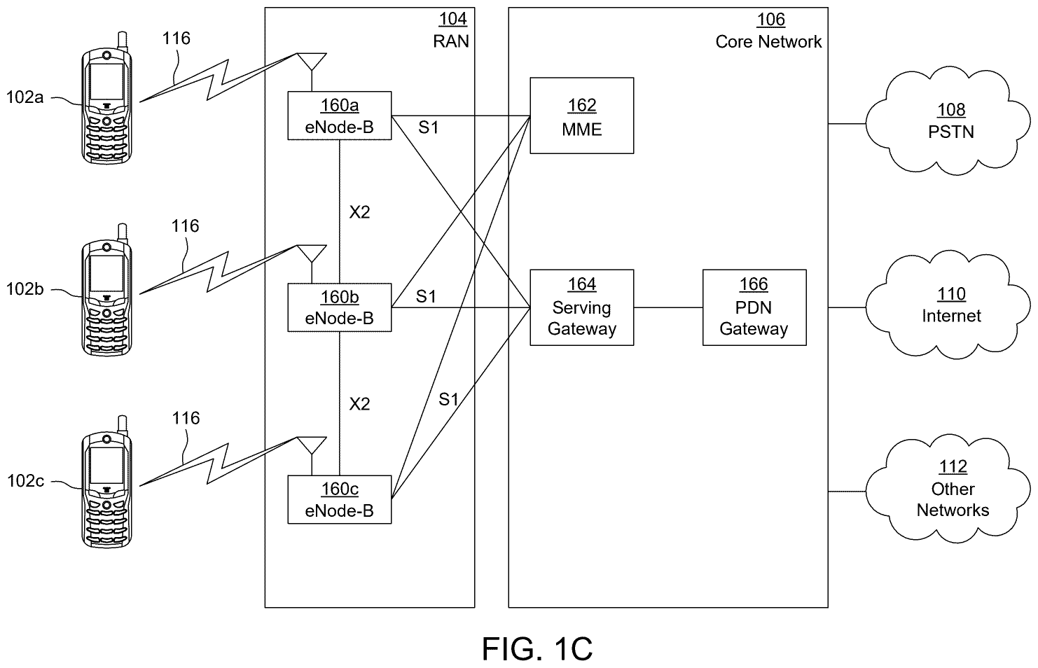

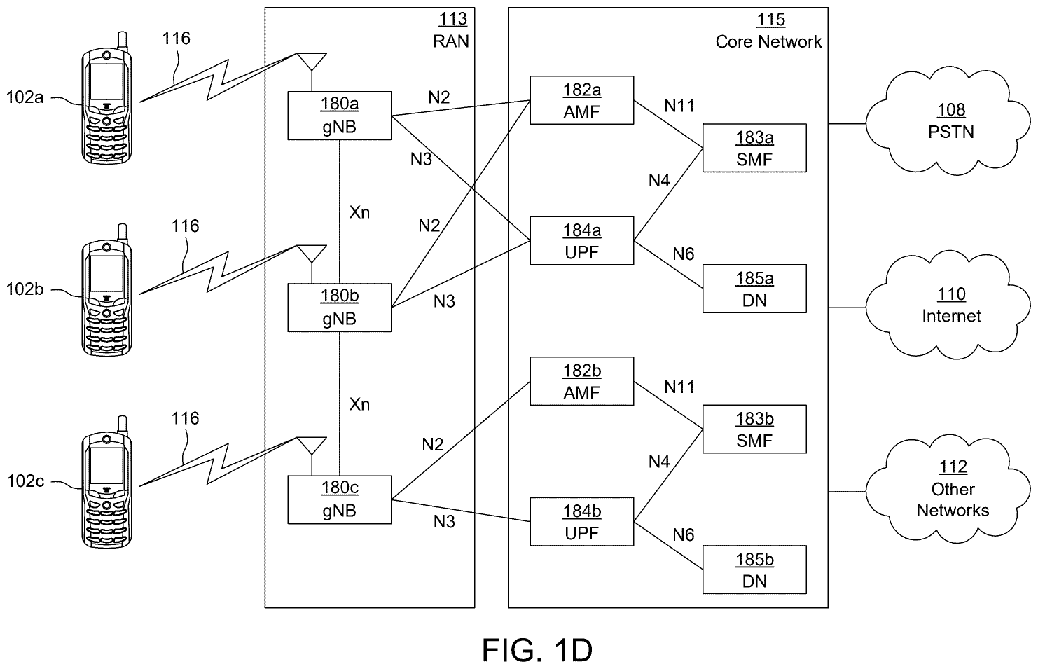

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the STA may back off for a certain period of time before sensing again. One STA (e.g., only one station) may transmit at any given space, time and frequency resource in each BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

### Operating Mode Indication (OMI)

OMI procedures are used between an OMI initiator such as a STA and OMI responder such as an AP and allows the OMI initiator to switch between different modes of operation by indicating changes in its transmission or receiver mode of operation to the responder. Such procedures were originally defined in 802.11ax and subsequently extended in 802.11be.

By way of generalized examples, an OMI initiator may use an OM Control subfield in data and management frames to switch between single-user or multi-user uplink OFDMA (UL-OFDMA) operations. This is referred to as the change in Transmit Operating Mode (TOM). An OMI initiator may also signal a change in Receive Operating Mode (ROM) to an AP (the responder), indicating a maximum number of spatial streams and maximum channel bandwidth it can support for downlink transmission.

As those skilled in the art will understand and appreciate, OMI procedures are crucial for optimizing the performance of WiFi 6 networks, ensuring that STAs (clients) can effectively communicate their capabilities and preferences to the AP for better network management and data transmission efficiency.

More specifically, an OMI initiator may change its receive operating mode (ROM) and/or transmit operating mode (TOM) by sending an OM Control subfield in a Quality of Service (QoS) Data, QoS Null or Class 3 Management frame to an addressed OMI responder which solicits an immediate acknowledgment from the OMI responder. The addressed OMI responder may update an operating channel width and a maximum Number of Spatial Streams (Nss) value, based on the most recently received OM Control subfield. The Nss defines the number of independent data channels that can be used to transmit and receive information simultaneously on a WiFi connection. Having more spatial streams generally allows for faster data rates and improved overall WiFi performance.

The OMI initiator supports transmitting/receiving Physical Layer Protocol Data Unit(s) (PPDUs) —a packet of data formatted specifically for transmission over a wireless medium—with a bandwidth up to a value indicated by a Channel Width subfield and the number of spatial streams as indicated in the TxNSTS/Rx Nss subfield of the OM Control subfield.

### OM Control Field in High Throughput (HT) Control Field

An HT Control field is always present in a Control Wrapper frame and is present in QoS Data, (802.11ax) QoS Null, and Management frames as determined by the +HTC subfield of the Frame Control field as defined in section 9.2.4.1.10 (+HTC subfield) of IEEE Std 802.11 Rev D5.0: Wireless LAN Medium Access Control (MAC) and Physical Layer (PHY) Specifications, February 2024. The HT Control field transmitted by a non-China Millimeter-Wave Multi-Gigabit (non-CMMG) STA has three variants: the HT variant, a Very High Throughput (VHT) variant, and a High Efficiency (HE) variant. Note that as used herein non-CMMG describes WiFi technologies using millimeter waves to achieve multi-gigabit speeds, excluding the China Millimeter-Wave Multiple Gigabit (CMMG) standard. Examples of such non-CMMG mmWave WiFi standards include IEEE 802.11ad and IEEE 802.11ay. The variant formats are differentiated by the values of B0 and B1 as defined in Table 1.

TABLE 1
HT Control Field Format

| Variant | B0 | B1 | B2-B29 | B30 | B31 |
|---|---|---|---|---|---|
| HT | 0 | HT Control Middle | | AC Constraint | RDG/More PPDU |
| VHT | 1 | 0 | VHT Control | AC Constraint | RDG/More PPDU |
| | | | Middle | | |

| | | | |
|---|---|---|---|
| HE | 1 | 1 | A-Control |

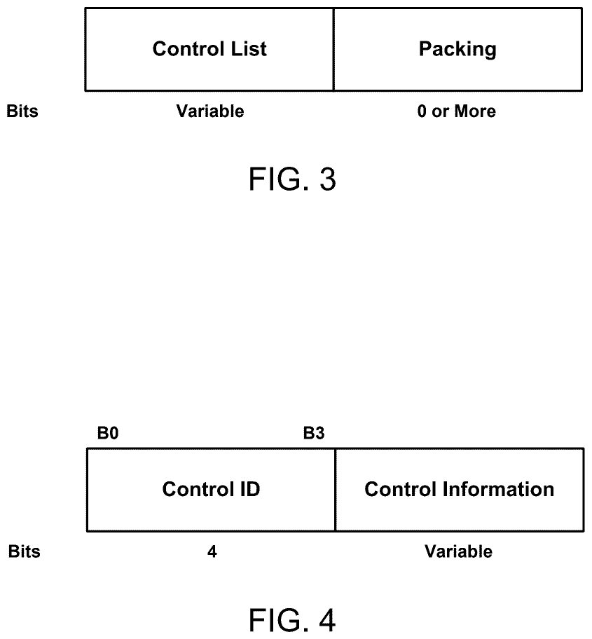

The format of the Aggregated Control (A-Control) subfield of the HE variant HT Control field is illustratively shown in FIG. 3. The A-Control subfield is 30 bits in length. As illustratively shown in that figure, the A-Control subfield includes a Control List subfield having a variable length and a Padding subfield having a length of 0 or more.

The Control List subfield contains one or more Control subfields including a Control ID subfield that is 4 bits in length and a Control Information subfield that is a variable number of bits in length. The format of each Control subfield is illustratively shown in FIG. 4.

The Control ID subfield indicates the type of information carried in the Control Information subfield. The length of the Control Information subfield is fixed for each value of the Control Id subfield that is not reserved. The Values of the Control ID subfield and associated length of the Control Information subfield are shown in Table 2.

TABLE 2
Control ID Subfield Values

| | | Length of the | Content of the |
|---|---|---|---|
| | | Control | control |
| Control ID | | Information | Information |
| Value | Meaning | subfield (bits) | subfield |
| 0 | Triggered response scheduling (TRS) | 26 | TRS Control |
| 1 | Operating mode (OM) | 12 | OM Control |
| 2 | HE link adaptation (HLA) | 26 | HLA Control |
| 3 | Buffer status report (BSR) | 26 | BSR Control |
| 4 | UL power headroom (UPH) | 8 | UPH Control |
| 5 | Bandwidth query report (BQR) | 10 | BQR Control |
| 6 | Command and status (CA) | 8 | CAS Control |
| 7 | EH operating mode (EHT OM) | 6 | EHT OM Control |
| 8 | Single response scheduling (SRS) | 10 | SRS Control |
| 9 | AP assistance request (AAR) | 20 | AAR Control |
| 10-14 | Reserved | | |
| 15 | One need expansion surely (ONES) | 26 | Set to all 1s |

The HE OM Control field subfield for 802.11ax WiFi is shown in Table 3.

TABLE 3
Control Information Subfield Format in an HE OM Control field

| | | | | | | |
|---|---|---|---|---|---|---|
| Rx | Channel | UL MU | Tx | ER SU | DL MU-MIMO | UL MU |
| NSS | Width | Disable | NSTS | Disable | Resound | Data |
| | | | | | Recommendation | Disable |

The Control Information subfield in an Extra High Throughput (EHT) OM control field subfield format in 802.11be is shown in Table 4.

TABLE 4
Control Information Subfield Format in an EHT OM Control Field

| | | | |
|---|---|---|---|
| Rx NSS | Channel | Tx NSTS | Reserved |
| Extension | Width | Extension | |
| | Extension | | |

### Multi-Link Operation (MLO)

MLO was introduced in 802.11be and this technology allows WiFi devices to use multiple bands simultaneously resulting in a significant boost in performance. MLO enables a non-AP multi-link device (MLD) to discover, authenticate, associate, and set up multiple links with an AP MLD. Operationally, an AP (referred to as a reporting AP) affiliated with an AP MLD may advertise operating capabilities and operating parameters of another AP (refer as reported AP) affiliated with the same AP MLD by including a Multi-Link Element. Each link enables channel access and frame exchanges between the non-AP MLD and the AP MLD based on the supported capabilities exchanged during their association.

### Problem Statements

### Dynamic Operating Mode Changes in Ultra High Reliability (UHR) WiFi

As may be readily appreciated by those skilled in the art, there exist numerous WiFi operational procedures that may advantageously employ dynamic operating mode changes requiring switches or changes from one operating mode to another. At present however, there exists no single structure/method/protocol for enabling such dynamic operating mode change(s) across all those numerous WiFi operational procedures.

The above problem is solved and an advance in the art is made according to aspects of the present disclosure which describes inventive methods and structures that solve such problems resulting from dynamic operating mode changes in UHR WiFi. Our inventive disclosure describes unified structure(s) for an Initial Control Frame (ICF) and Initial Response Fame (IRF) and methods that employ an ICF/IRF exchange between a STA and AP, operating in a WiFi network, which advantageously enables a number of the dynamic mode changes used by the WiFi operational procedures.

### Embodiments

### Dynamic Operating Mode Change Operation Procedure

Dynamic operating mode change may be a temporal mode change between a pair of STAs or a group of STAs. The change may be transient and happen within a TXOP and the STAs may change back to the original mode after the end of the TXOP or after certain time defined in the mode change related parameters/frames or after certain criteria are met. We may refer the original mode as Mode 1 and transient mode as Mode 2 in this disclosure.

In general, a STA (e.g., AP or non-AP STA) may initiate the mode changing and the STA may be referred as the DMC initiator. One or more STAs may respond to the mode changing and the STA(s) may be referred as the DMC responder(s).

Different operation modes may be defined and STAs (including APs and non-AP STAs) may switch between the modes by transmitting an initial control frame (ICF) and an initial response (ICR) frame. The second mode related parameters may be carried in the ICF and/or ICR frame.

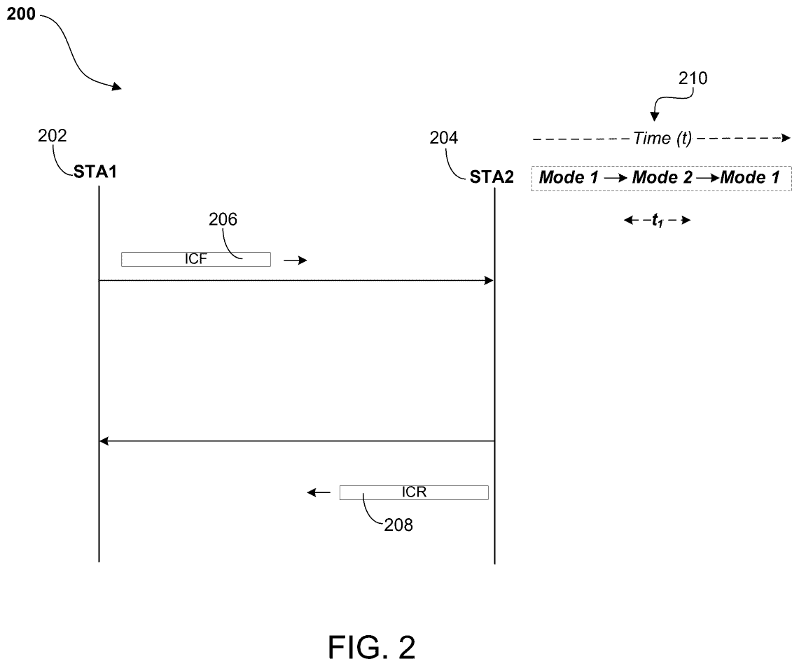

FIG. 2 illustrates an embodiment 200 of a dynamic operating-mode change (DMC) in a WiFi network according to aspects of the present disclosure. A dynamic operating mode change may be a temporal mode change between a pair of STAs, such as STA 202 and STA 204, or a group of STAs. The mode change may be transient and occur within a TXOP, whereby the STAs may change back to their original mode after the end of a TXOP; after a certain time defined in the mode change related parameters/frames; and/or after certain one or more criteria are met. For example, a current/original mode may be referred to as Mode 1 and a following transient mode as Mode 2.

A STA (e.g., AP or non-AP STA) initiating the mode change may be referred as the DMC initiator. One or more STAs responding to the mode change may be referred to as DMC responder(s). Different operation modes may be defined and communicating STAs (including APs and non-AP STAs) may switch between the modes by transmitting a control frame such as an initial control frame (ICF) and a response frame such as an initial response (ICR) frame. The parameters and information related to the transient second mode (e.g., mode 2) may be carried in the ICF and/or ICR frame.

Further referring to FIG. 2, STA 202 may be a DMC initiator which transmits an ICF frame 206 to another STA 204 acting as a DMC responder. Based on the operating mode change parameters (e.g., power mode change information) that may be carried in the ICF frame 206, STA 204 switches from a first operating mode (e.g., mode 1) to a second operating mode (e.g., mode 2) that is different than the first operating mode. The DMC responder STA 204 may then transmit an ICR frame 208 in response to the received ICF frame, whereby information regarding the mode change (e.g., status information) is sent back to the DMC initiator STA 202. As indicated by 210, the DMC responder STA 204 may dynamically undergo a mode change from mode 1 to mode 2, followed by a transition from mode 2 back to mode 1 after a period of transient time t₁.

Numerous operating modes are possible with our inventive operations and structures, and several exemplary modes may be defined as follows.

### Low Power Mode

WiFi Low Power Mode refers to settings that that optimize and/or improve power consumption of WiFi devices. In this mode, the device conserves energy by reducing its activity and entering a low-power state when, for example, the demand for network traffic is low or when its operating on battery power. When a STA is operating in low power mode, it may transmit and/or receive using this mode. For example, a low power mode may be defined by a narrow bandwidth (or below a bandwidth threshold), a low Modulation Coding Scheme (MCS), or below a MCS threshold, and/or a low number of spatial streams (or below a certain number of spatial stream threshold) even though it may be capable of transmitting/receiving on a larger range of bandwidths, MCSs, and number of spatial streams.

### High Power Mode

WiFi High Power Mode refers to settings that maximizes/improves the performance of WiFi devices at the expense of higher power consumption. This mode may be useful when then WiFi network covers a large area or when high data throughput is required. When a STA is operating in high power mode, it may transmit and/or receive using this mode. For example, the mode may be defined by a wider bandwidth (or within a bandwidth range), a high MCS (or within an MCS range), and/or a high number of spatial streams (or within a number range of spatial streams) even though it may be able to transmit/receive on a smaller range of bandwidths, MCSs, and number of spatial streams.

### Primary Channel Transmission Mode

WiFi Primary Channel Transmission Mode refers to a main channel over which a WiFi AP communicates with its connected devices (STAs). This primary channel is used for signaling and maintaining compatibility with older devices that may not support channel bonding, which is the use of multiple channels for increased bandwidth. When a STA is operating in primary channel transmission mode, it will transmit/receive using at least the primary channel (e.g., primary 20 MHz channel) and it may perform Clear Channel Assessment (CCA) and Network Allocation Vector (NAV) setting on the primary channel. As is known by those skilled in the art, CCA in primary channel mode is a part of the Carrier Sense Multiple Access with Collision Avoidance (CSMA/CA) protocol used in WiFi networks. It is a mechanism that helps prevent data collisions by ensuring that a WiFi channel is clear before a device attempts to transmit data using it. Similarly, WiFi NAV in the primary channel is a virtual carrier-sensing mechanism used in the IEEE 802.11 protocol. It helps manage the use of the medium and prevents collisions by indicating the amount of time (in microseconds) that the medium will be busy. This is the default operating mode as compared to a non-primary transmission mode.

### Non-Primary Channel Transmission Mode

WiFi Non-Primary Channel Transmission Mode refers to the use of additional channels beyond the primary channel for data transmission. This concept is particularly relevant in the context of latest WiFi standards, such as IEEE 802.11be (WiFi 7), which supports wider bandwidths and the use of multiple channels to increase throughput and efficiency. The adoption/use of non-primary channel transmission modes is a significant step towards optimizing wireless network performance, especially in environments with high demand for data throughput and low latency. When a STA is operating in the non-primary channel transmission mode, it will transmit/receive using a non-primary channel (e.g., not the primary 20 MHz channel) and it may perform CCA and NAV setting on the non-primary channel. The STA may remain in this mode temporarily and switch back to the primary channel transmission mode if possible. One exemplary use of this mode is when the primary channel is occupied by an overlapping BSS (OBSS) transmission and thus APs and non-AP STAs have to operate on a non-primary channel.

### Static Subchannel Transmission Mode

WiFi Static Subchannel Transmission Mode refers to an operational configuration in which a STA transmits/receives on a channel that includes the primary channel.

### Dynamic Subchannel Transmission Mode

WiFi Dynamic Subchannel Transmission Mode refers to an operational configuration in which a STA transmits/receives on a channel that does not include the primary channel. Those skilled in the art will understand and appreciate that this mode may be useful when a STA is a narrowband capable STA and its associated AP may operate using a wide channel width. The AP may request the STA to operate temporarily on a subchannel which does not include the primary channel.

### In-Device Interference Free Mode

WiFi In-Device Interference Free Mode refers to an operational configuration that minimizes or lessens the impact of interference caused by other electronic devices. This mode is designed to ensure that the WiFi signals remain strong and stable, even in environments where multiple devices may be operating on similar frequency bands which could disrupt the WiFi connection. When a STA is operating in the In-Device Interference Free Mode, the STA may not experience any in-device interference event.

### In-Device Coexistence Mode

WiFi In-Device Coexistence Mode refers to an operational configuration that allows multiple wireless technologies to operate simultaneously within a same device without causing harmful interference to each other. This is particularly important in devices that support various wireless standards such as WiFi, Bluetooth, Zigbee, and Thread, all of which may operate in a 2.4 GHz band. When a STA is operating in the In-Device Coexistence Mode, the STA may experience some in-device interference events.

### Static Puncturing Mode

WiFi Static Puncturing Mode builds upon the concept of “puncturing” that is related to a feature known as Preamble Puncturing, which is used in WiFi 6 (802.11ax) and WiFi 7 (802.11be) technologies. Preamble puncturing is a feature that improves spectral efficiency by allowing a WiFi AP to transmit over a portion of the spectrum channel, even if some of the channel is being used by legacy users or there is interference. This means that if there is interference on a part of the channel, the AP can “puncture” that part and still use the remainder of the channel for transmission, enabling wider channels than would otherwise be available. When a STA is operating in the Static Puncturing Mode, the STA may use static puncturing identified/signaled in a Disabled Subchannel Bitmap carried in a Beacon Frame or a Management Frame.

### Dynamic Preamble Puncturing Mode

WiFi Dynamic Puncturing Mode is an advanced feature that builds upon the concept of preamble puncturing that was introduced in WiFi 6. It allows a WiFi AP to dynamically adjust and transmit over portions of the spectrum channel, avoiding parts that are used by legacy or users or subject to interference. Unlike static puncturing, which is predetermined, dynamic preamble puncturing may adapt in real-time to a changing radio environment. By avoiding interference dynamically, it maintains spectral efficiency and ensures favorable/best possible use of the available spectrum. This mode advantageously enables the use for wider channels—even when some parts of the spectrum are occupied—by dynamic puncturing the spectrum to avoid the occupied parts. It is particularly useful in environments with fluctuating interference or when dealing with overlapping channels and may produce more intelligent and efficient spectrum management that may be crucial for the high density, high throughput demands of modern WiFi networks such as those employing WiFi 7 (802.11be) technologies. When a STA is operating in Dynamic Preamble Puncturing Mode, the STA may puncture additional subchannels other than that indicated in the Disabled Subchannel Bitmap carried in the Beacon Frame or Management Frame.

As those skilled in the art will now understand and appreciate, we may define many dynamic mode change (DMC) types and procedures that facilitate/allow mode changing within a subset of the above-described modes—and others.

By way of non-limiting illustrative example, a power saving (PS) mode type may be defined, allowing changing between the low power mode and the high-power mode. An NPCA mode type may be defined, allows changing between the primary channel transmission mode and the non-primary channel transmission mode. A coexistence mode type may be defined, allowing changing between the in-device interference free mode and the in-device interference mode. A DSO mode type may be defined, allowing changing between the static subchannel operation mode and the dynamic subchannel operation mode. Finally, a dynamic preamble puncturing (DPP) mode type may be defined, allowing changing between the static puncturing mode and the dynamic puncturing mode.

Operationally, a STA (e.g., AP or non-AP STA) may initiate the mode change and therefore may be referred to as a “DMC initiator”. One or more STAs may respond to the mode change initiated by the DMC initiator and such responding STAs may be referred to “DMC responder(s)”.

### Mode Classes

We note that while a particular mode change procedure may be different even within a same mode type, nevertheless—and advantageously according to aspects of the present disclosure—there is overlapping commonality even among different types of mode change procedures that provides both simplicity and flexibility. In furtherance of that simplicity and flexibility, we have classified our inventive dynamic mode changing into three dynamic mode classes.

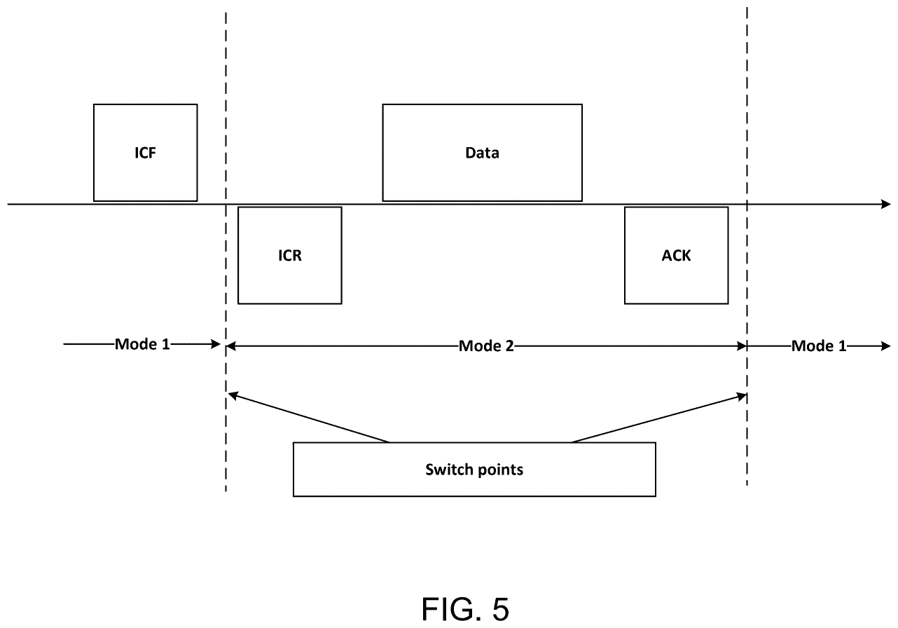

FIG. 5 shows an illustrative Dynamic Mode Class 1 dynamic mode change of Mode 1 to transient Mode 2 and return to Mode 1 in which an Initial Control Frame (ICF) is transmitted using Mode 1 and an Initial Control Response (ICR) is transmitted using Mode 2, according to aspects of the present disclosure.

With reference to that figure, it may be observed that a Dynamic Mode Class 1 dynamic mode change operation includes an ICF that is transmitted using one mode, Mode 1 in this illustrative example, and an ICR that is transmitted using another mode, Mode 2 in this illustrative example. Operationally, a DMC initiator transmits the ICF frame which may convey a mode type and mode class such that a DMC responder may respond appropriately and determine what mode—if any—it may switch to. The ICF may also convey detailed mode related parameters and/or when the mode switch may occur and/or how long the STAs may remain in the switched-to mode. The ICF may be padded and allow the responder enough time to switch modes. After switching to the second mode, the DMC responder may respond with an ICR frame. The frame exchanges following the ICR may be made in second mode until the end of the Transmission Operation (TXOP), or a frame including explicit indication is sent from the DMC initiator and/or responder to end the mode change or switch back to the first mode.

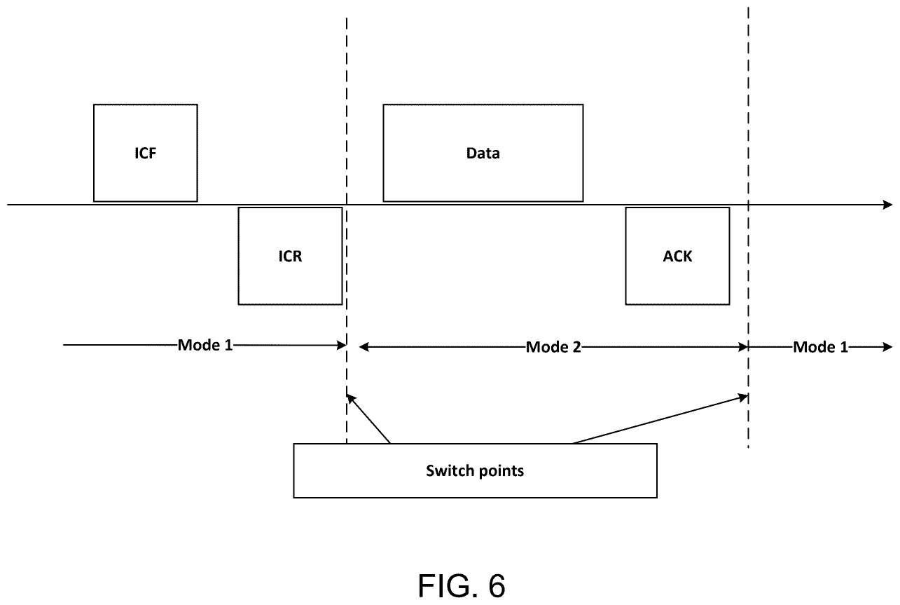

FIG. 6 shows an illustrative Dynamic Mode Class 2 dynamic mode change of Mode 1 to transient Mode 2 and return to Mode 1 in which an Initial Control Frame (ICF) and an Initial Control Response (ICR) are transmitted using Mode 1 before mode change, according to aspects of the present disclosure.

With reference to that figure, it may be observed that a Dynamic Mode Class 2 dynamic mode change operation includes an ICF and an ICR that are both transmitted using Mode 1 in this illustrative example—before a mode change to Mode 2. Operationally, a DMC initiator transmits the ICF frame which may convey a mode type and mode class such that a DMC responder may respond appropriately and determine what mode—if any—it may switch to. The ICF may also convey detailed mode related parameters and/or when the mode switch may occur and/or how long the STAs may remain in the switched-to mode. According to this Dynamic Mode Class 2 dynamic mode change operation, the DMC responder may respond with an ICR frame while it is in Mode 1, before switching to Mode 2. The frame exchanges following the ICR may be made in second mode until the end of the Transmission Operation (TXOP), or a frame including explicit indication is sent from the DMC initiator and/or responder to end the mode change or switch back to the first mode. Similar to the Dynamic Mode Class 1 operation, the ICF/ICR exchange may indicate a time or duration when transmissions are changed from Mode 1 to Mode 2, and/or from Mode 2 to Mode 1.

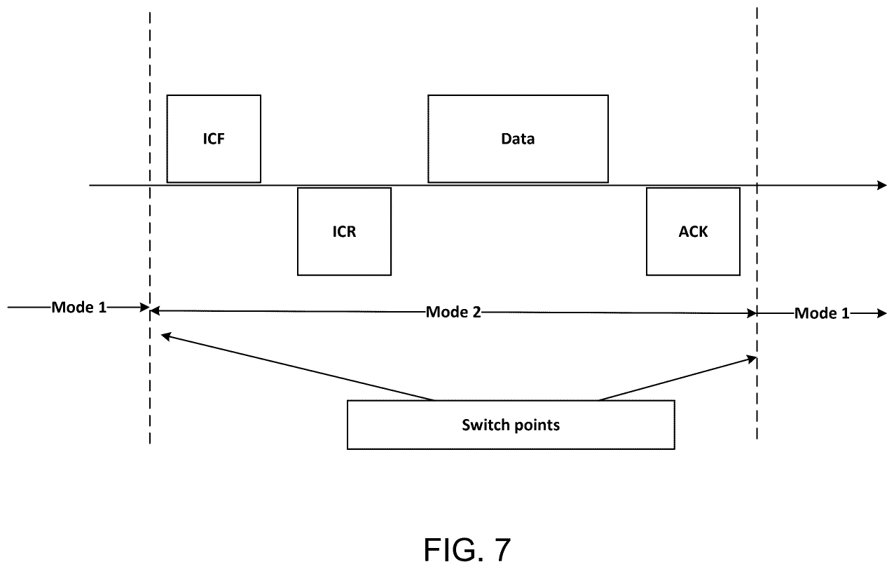

FIG. 7 shows an illustrative Dynamic Mode Class 3 dynamic mode change of Mode 1 to transient Mode 2 and return to Mode 1 in which an Initial Control Frame (ICF) an Initial Control Response (ICR) are transmitted using Mode 2, after an initial mode change, according to aspects of the present disclosure.

With reference to that figure, it may be observed that a Dynamic Mode Class 3 dynamic mode change operation includes an ICF and an ICR that are both transmitted using Mode 2 in this illustrative example—after a mode change to Mode 2 from Mode 1. Operationally, a DMC initiator transmits the ICF frame announcing that it has switched to Mode 2, which may convey a mode type and mode class such that a DMC responder may respond appropriately and determine what mode—if any—it may switch to. The ICF may also convey detailed mode related parameters and/or when the mode switch may occur and/or how long the STAs may remain in the switched-to mode. According to this Dynamic Mode Class 3 dynamic mode change operation, the DMC responder responds with an ICR frame while it is in Mode 2. The frame exchanges following the ICR are made in the second mode (Mode 2) until the end of the Transmission Operation (TXOP), or a frame including explicit indication is sent from the DMC initiator and/or responder to end the mode change or switch back to the first mode. The ICF/ICR exchange may indicate a time or duration when transmissions are changed from Mode 2 to Mode 1.

### Mechanisms to Switch Back to Original Mode

According to aspects of the present disclosure, the time duration that STAs remain in the transient mode, or the second mode may be explicitly or implicitly signaled in the ICF/ICR frame. In one illustrative method, the Duration field in the MAC header of the ICF/ICR frame may indicate the time duration the STA remained in the second mode. In another illustrative method, the ICF/ICR frame may carry a Second Mode Duration field to explicitly indicate the time duration to remain in the second mode. In yet another illustrative method, the ICF/ICR may carry information which indicates the condition that the STAs may switch back from the second mode to the first mode. In one example, the TXOP holder or the DMC initiator may transmit a CF-END frame or other frame to indicate the end of the second mode. In still another illustrative example, the TXOP responder or the DMC responder may transmit a CF-END frame or other frame to indicate the end of the second mode. In still another illustrative example, the TXOP responder or the DMC responder may switch back to the first mode if it does not receive any valid transmissions address to it during a predefined/predetermined period. With this example, the predefined/predetermined period may be carried in a Capabilities IE, or Operation IE or another IE or field in a management/control/data frame by an AP or a non-AP STA.

### DMC Roles

With different mode change procedures, the ICF may be initiated by an AP or a non-AP STA. It may be transmitted from one transmitter to one receiver or multiple receivers. The ICR may be transmitted by an AP or a non-AP STA. It may be transmitted from one transmitter or multiple transmitters to one receiver. There may be an explicit signaling to signal a particular way to transmit the ICF or ICR frame. We may use DMC Role field/subfield to convey this information.

### Status Code

A Status Code field may be included in the ICF and ICR. When it is included in an ICF, the Status Code may indicate the frame change request is either required or suggested. When it is included in an ICF, the Status Code may indicate the mode parameters carried in the ICF is accepted, rejected or a new set of parameters is proposed.

For example, a Status Code field may be included in the ICF and ICR. When the Status Code is included in the ICF, it may take different values which may include the following.

SUGGEST is used to indicate that the DMC responder is suggested to use operating parameters set by the DMC initiator.

DICTATE is used to indicate that the DMC is required to use the operating parameters set by the DMC initiator.

In one illustrative method, when Status Code field may be included in the ICR. This code may take different values which may include the following.

SUCCESS is used to indicate that the TXOP responder/DMC responder accepted the operating parameters suggested by the DMC Initiator.

DECLINED is used to indicate that the TXOP responder/DMC responder declined the request of the DMC Initiator.

SUGGESTED_PARAMETERS is used to indicate that the TXOP responder/DMC responder is suggesting other operating parameters to the DMC Initiator which can be determined by TXOP responder/DMC responder based on its capabilities

### Unified Frame for Dynamic Operating Mode Change

As those skilled in the art will now understand and appreciate, we have defined illustrative unified frame(s) that advantageously enable then dynamic operating mode changes previously outlined.

### Unified Frame Design Considerations

As noted, unified frame designs/structures for ICF/ICR frames may be advantageous and preferred as such designs may improve efficiency and flexibility of mode change operations such as those described and contemplated. In considering unified frame design(s), we note that in some illustrative instances, an ICF may be initiated by an AP, transmitted to one or more non-AP STAs, and the ICR frame may be transmitted via uplink by a non-AP STA to the AP.

In other illustrative instances, the ICF may be initiated by a non-AP STA. and the ICR frame may be transmitted by the AP as a response frame.

In still other illustrative instances, the ICF/ICR frames may need to be carried in a legacy Physical Layer Protocol Data Unit (PPDU), e.g., non-HT Duplicate PPDU, such that legacy STAs are able to understand the frame—at least partially—and set a Network Allocation Vector (NAV) based on information received.

Finally, in still further illustrative instances, ICR frames may need to carry user specific information such that the DMC initiator is able to distinguish which STAs responded with ICR frames. Moreover, the DMC responder may be able to respond with its preference of the operating parameters with the new mode.

With these preliminary considerations in place, we may now describe general design considerations for our unified frame design(s) that advantageously enable dynamic operating mode change(s) according to aspects of the present disclosure.

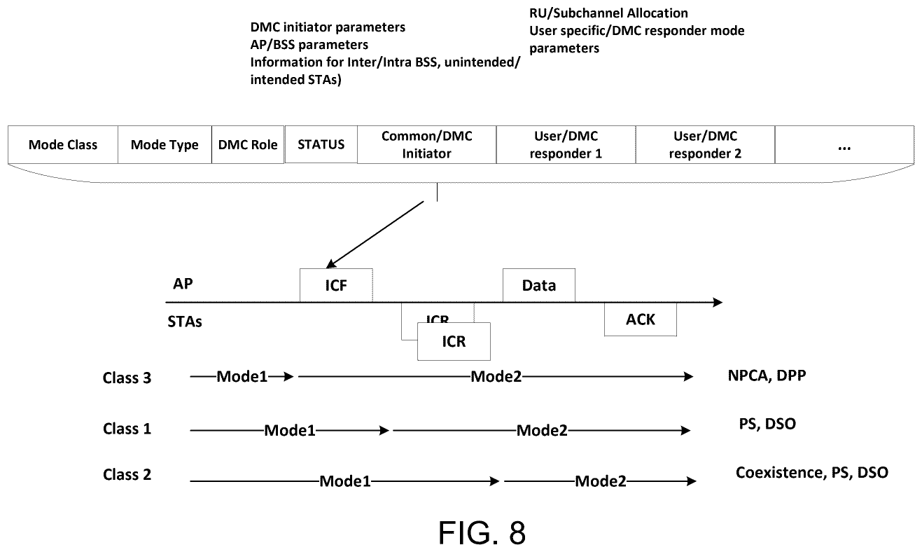

FIG. 8 shows illustrative ICF design considerations when the ICF is initiated by an AP according to aspects of the present disclosure. With reference to that figure, shown therein is an illustrative ICF with multiple fields including Mode Class field, Mode Type field, DMC Role field, Status field, Common/DMC Initiator field, User/DMC responder 1 field, and User/DMC responder 2 field. While additional fields may be defined subsequently, they are not specifically shown in this figure.

With respect to the fields shown, the Mode Class field of the ICF carries information that may be used by DMC responder(s) to determine the specific mode that may be used to transmit the response frame.

The Mode Type field of the ICF carries information pertaining to mode type. Exemplary mode types may include those described previously namely, NPCA, PS, DSO, Coexistence, and DPP. In this illustrative example shown in FIG. 8, PS and DSO modes are illustratively shown as mode Class 1 and mode Class 2, Coexistence mode is illustratively shown as mode Class 2, and NPCA and DPP are illustratively shown as mode Class 3.

Note some mode types may be classified into two or more mode classes. For example, DSO and PS may be in Mode Class 1 and Mode Class 2. As those skilled in the art will readily understand and appreciate, the combination of Mode Type and Mode Class conveyed in our inventive and illustrative ICF structure may uniquely determine DMC responder behavior.

With continued reference to FIG. 8, we note that the ICF may also contain a DMC Role subfields that may indicate whether the STA transmitting the ICF is a DMC initiator or a DMC responder. In essence, this indicates whether this is an ICF or an ICR frame. In one illustrative method, the DMC Role subfields may indicate whether the transmission is a unicast transmission, a multicast/broadcast transmission, or a part of a multiple access transmission (i.e., more than one STA transmitting concurrently).

An exemplary frame format of the DMC Roll subfields is illustratively shown in Table 5.

TABLE 5
DMC Role Subfield Format

| | |
|---|---|
| DMC Initiator | Number of DMC Responders |

The DMC Initiator subfield of the DMC Role subfield may indicate if the transmission is from a DMC initiator or not (e.g., from a DMC responder). The Number of DMC Responders subfield may indicate the number of the DMC Responders. In one illustrative method, the value of the Number of DMC Responders subfield may be an exact value. In another illustrative method, the value of the Number of DMC Responders subfield may be a quantized value. For example, the subfield may be a one-bit subfield, and a value of 0 may indicate there is one DMC responder and value of 1 may indicate there is more than one DMC responder. As will be understood and appreciated, these numbers and subfield length(s) are only illustrative and our inventive concept of a DMC Role subfields and information they convey are not so limited. If the DMC Role subfield format was changed such that it conveys more than one bit of information, than the quantization resolution may be finer.

To illustrate utility of the DMC Role subfield operationally, we note that upon reception of the DMC Role Subfield by one or more receiving STAs, if the DMC Initiator subfield is set to true, and Number of DMC Responders subfield indicates only one DMC Responder, then the receiving STAs will know that the ICF is a unicast transmission. If the DMC Initiator subfield is set to true, and Number of DMC Responders subfield indicates more than one DMC Responder, then the receiving STAs will know the ICF is a multicast transmission. If, however, the DMC Initiator subfield is set to false, and Number of DMC Responders subfield indicates only one DMC Responder, then receiving STAs will know the ICR is a unicast transmission. If the DMC Initiator subfield is set to false, and Number of DMC Responders subfield indicates more than one DMC Responder, then the receiving STAs will know the ICR is a multiple access transmission. Note that the DMC Roll subfield may be included in an ICR frame also.

The ICF may also contain a Status Code subfield. When it is included in an ICF, the Status Code may indicate the frame change request is required or suggested. When it is included in an ICF, the Status Code may indicate the mode parameters carried in the ICF is accepted, rejected or a new set of parameters is proposed

With continued reference to FIG. 8, note that the ICF includes a Common/DMC Initiator Info field, which in turn illustratively conveys DMC initiator parameters (e.g., mode related parameters), AP/BSS parameters (e.g., mode related parameters), and/or information for inter/intra-BSS, and information for intended/unintended STAS (e.g., information for unintended STAs to set NAV, perform spatial reuse transmission, etc.). The detailed parameters carried in the Common/DMC Initiator Info field may depend upon the Mode Type and/or Mode Class fields and/or DMC Role field.

We note that the ICF may carry one or more User/DMC responder Info fields. Each User Info field may carry user ID, user specific parameters (e.g., mode related parameters) of the second mode, RU or subchannel allocation for the ICR transmission. The AP/DMC initiator may request or suggest the non-AP STA/DMC responder to operate using the user specific parameters. The detailed parameters carried in the User Info field may depend on the Mode Type and/or Mode Class fields and/or DMC Role field.

In one illustrative method, the fields carried in a Trigger frame may be carried in the ICF to assign uplink transmission parameters. As those skilled in the art will understand and appreciate, a Trigger frame is a type of control frame used in IEEE 802.11 wireless LAN protocols, specifically in the 802.11ax (WiFi 6) standard. It is designed for multiple purposes, one of which is to allocate resources for a specific multi-user Orthogonal Frequency Division Multiple Access (OFDMA) transmission.

The Trigger frame is generally sent by an AP to coordinate with multiple STAs in the network to inform them when and how they can send data. This helps in managing airtime efficiently, especially when multiple devices need to communicate simultaneously. The trigger frame contains information such as the length of the expected response frame, the bandwidth of the transmission and the details on each STA participating in upcoming OFDMA transmission(s).

For example, the Trigger frame carries subfields such as Uplink (UL) Length, UL Bandwidth (BW), Guard Interval (GI) and Long Training Field (LTF) Type, Number of LTF Symbols, AP Tx Power, Pre-FEC Padding Factor, Packet Extension (PE) Disambiguity, UL Spatial Reuse, Universal Signal (U-SIG) Reserved, P160, Uplink Modulation and Coding Scheme (UL MCS), UL Target Receive Power subfields etc. Some of the above-mentioned subfields may be included in the Common/DMC Initiator field and some subfields may be included in the User/DMC Responder List field. A More ICF subfield may also be included in future revisions of our inventive structures to indicate if more ICF frames may be included in the TXOP. We note that P160 is defined in EHT variant Trigger frame to indicate whether the allocated resource unit is in a primary 160 Mhz channel or a secondary 160 Mhz channel.

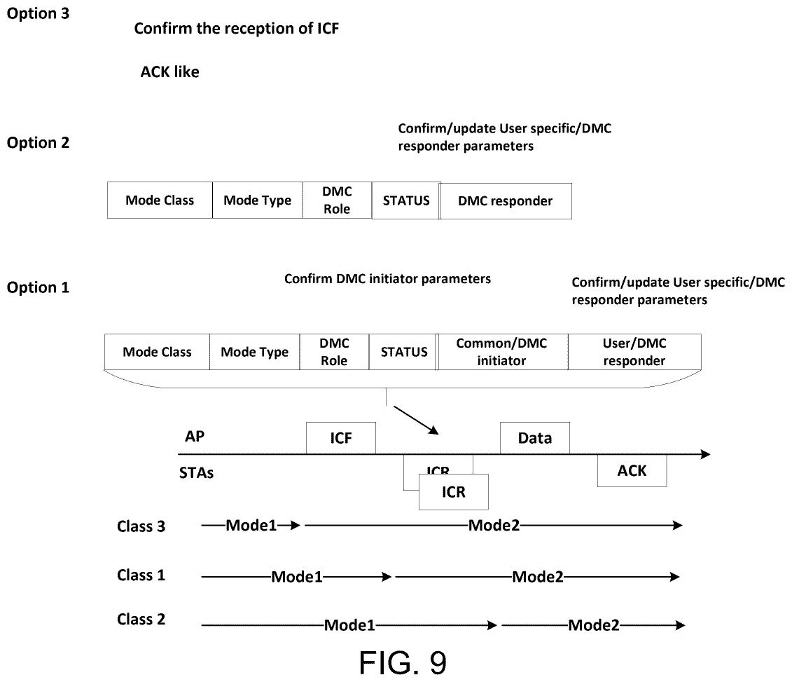

FIG. 9 shows three optional, illustrative ICR design considerations when the ICR is initiated by an AP according to aspects of the present disclosure. With reference to that figure, it may be observed that three different, optional, ICR designs are presented.

With option 1, the ICR frame may have the same format as the ICF, i.e., the ICR may contain a Mode Class field, Mode Type field, DMC Role field, Status Code field, Common/DMC Initiator Info field and User/DMC Responder Info field. The Mode Class field, Mode Type field, DMC Role field, and Status Code field are the same as defined in the ICF. The Common/DMC initiator Info field may carry the same information carried in the Common/DMC initiator Info field of the ICF.

The DMC responder may repeat the information such that some unintended STAs that are hidden from a DMC initiator may be able to detect it. In one illustrative method, the User/DMC responder Info field may carry the same information as the User/DMC responder Info field of the ICF addressed to the DMC responder if the DMC responder accepts the parameters. With this method, the non-AP STA may—to some extent—be able to choose its operating parameters of the second mode. In one method, the DMC responder may reject the proposed mode change by setting the Status Code field to DECLINED. In this case, the User/DMC responder Info field may be reserved or not transmitted

With option 2, the ICR frame may include the Mode Class field, Mode Type field, DMC Role field, Status Code field, and DMC Responder Info field. Advantageously, and according to an aspect of the present disclosure, the Mode Class field, Mode Type field, DMC Role field, and Status Code field are the same as those defined in the ICF and provide a foundational basis for our inventive common frame.

The DMC Responder Info field may carry the information about the DMC responder. Terminology wise, we may refer it as the Common Info field or the User Info field. In one method, the DMC Responder Info field may carry the same information as the User/DMC Responder Info field of the ICF addressed to the DMC responder. In one method, the DMC Responder Info field may carry the updated information based on the User/DMC Responder Info field of the ICF addressed to the DMC responder. With this method, the non-AP STA may be able to choose its operating parameters of the new mode to some extent. In one method, the DMC responder may reject the proposed mode change by setting the Status Code field to DECLINED. In this case, the User/DMC responder Info field may be reserved or not transmitted.

At this point we note that with both option 1 and option 2, the ICR frame contains user specific information (e.g., AID) and thus it is distinguishable from one DMC responder to another. Note further than an ICR frame with option 1 or option 2 may be transmitted using orthogonal resource unit in time/frequency or orthogonal in spatial domain. The detailed parameters carried in the fields other than the Mode Class and Mode Type field if present may depend on the Mode Type and/or Mode Class fields.

With option 3, an ICR frame may be used to confirm the reception of an ICF, and thus the ICR may contain limited information like traditional Clear To Send (CTS) frame or ACK frame. With this design option 3, the ICR frame may be simple enough that it may be the same among all the DMC responders and thus overlapping transmission (i.e., overlapping in time and frequency domain) of the ICR frame from multiple DMC responders may be possible and detectable. In one illustrative method, the ICR frame may advantageously contain the Mode Class field, Mode Type field, and DMC Role field.

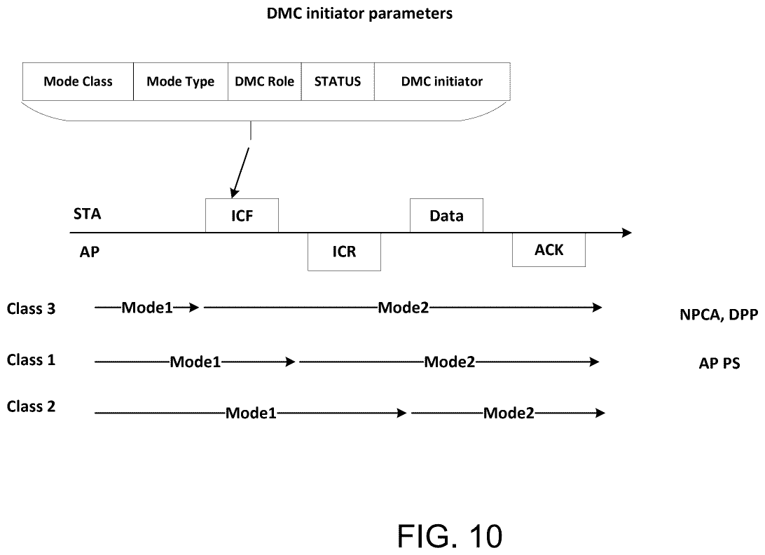

FIG. 10 shows illustrative ICF design considerations when the ICF is initiated by a non-AP STA according to aspects of the present disclosure.

With reference to that FIG. 10, it may be observed that Mode Class field, Mode Type field, DMC Role field, and Status Code field may advantageously be included in this ICF and convey information as shown previously with respect to other illustrative designs. Additionally, the ICF may include a Common/DMC Initiator Info field, which may carry DMC initiator parameters (e.g., mode related parameters), and/or AP/BSS parameters (e.g., mode related parameters), and/or information for inter/intra-BSS, and information for intended/unintended STAs (e.g., information for unintended STAs to set NAV, perform spatial reuse transmission etc.). The detailed parameters carried in this Common Info field may depend on the Mode Type and/or Mode Class fields and/or Status Code fields.

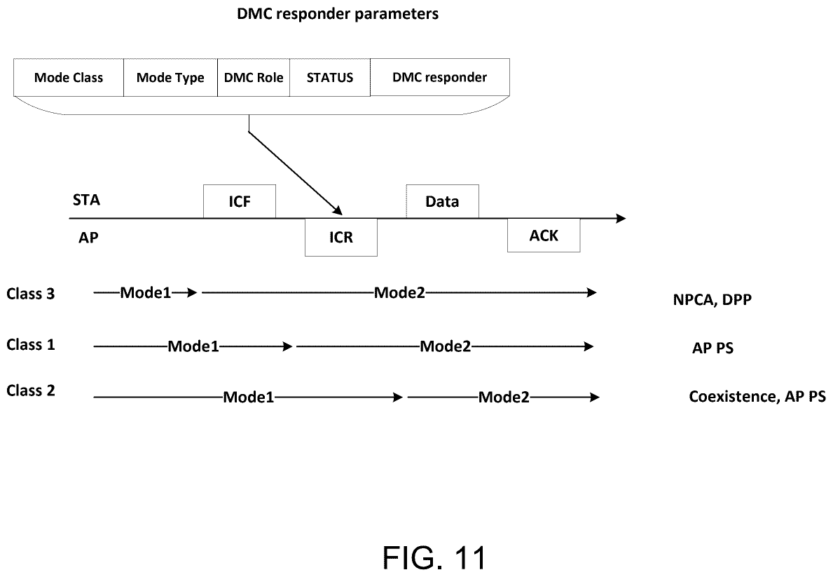

FIG. 11 shows illustrative ICR design considerations when the ICF is initiated by a non-AP STA according to aspects of the present disclosure. With reference to this FIG. 11, we note that in this illustrative case the ICR frame is transmitted by an AP. The ICR may contain a Mode Class field, Mode Type field, DMC Role field, Status Code field, and DMC Responder Info field. The Mode Class field, Mode Type field, DMC Roll field, and Status Code field are the same as defined in the ICF. The DMC Responder Info field may carry the same information related to the DMC responder, i.e., the AP. For example, the DMC Responder Info field may carry DMC responder mode parameters and BSS level parameters for unintended STAs etc. The DMC Responder Info field may also carry whether the AP may accept, reject, or suggest a particular mode change for the non-AP STA.

### Dynamic Operating Mode Change Action Frame

We now disclose a new frame that is defined for the initial control frame and/or the initial response frame. In this illustrative embodiment, we use a newly defined Action frame as an example to show information that is included in the ICF and ICR. The newly defined action frame may be referred as Dynamic Operating Mode Changing Action frame.

An UHR Action field values may be used to indicate UHR Action frames. Table 6 shows an example where UHR Action field value 0 may indicate a UHR Dynamic Operating Mode Change frame.

TABLE 6
UHR Action field values

| Value | Meaning |
|---|---|
| 0 | UHR Dynamic Operating Mode Changing |

The UHR Dynamic Operating Mode Change frame may be an Action No Ack frame of category UHR. In one illustrative method, it may be a Protected UHR Action frame. The UHR Dynamic Operating Mode Change frame may include the information illustratively shown in Table 7.

TABLE 7
UHR Dynamic Operating Mode Change frame format

| Order | Meaning |
|---|---|
| 1 | Category |
| 2 | UHR Action |
| 3 | UHR Mode Control |
| 4 | UHR Power Saving Request (ICF PS) |
| 5 | UHR Power Saving Response (ICR PS) |
| 6 | UHR NPCA Request |
| 7 | UHR NPCA Response |
| 8 | UHR DSO Request |
| 9 | UHR DSO Response |
| 10 | UHR Coexistence Request |
| 11 | UHR Coexistence Response |
| 12 | UHR Dynamic Preamble Puncturing (DPP) Request |
| 13 | UHR Dynamic Preamble Puncturing (DPP) Response |

With reference to that Table 7, we note that a UHR Dynamic Operating Mode Change frame which contains UHR Power Saving Request field may be referred as a Power Saving Request frame. A UHR Dynamic Operating Mode Change frame which contains UHR Power Saving Response field may be referred as a Power Saving Response frame. A UHR Dynamic Operating Mode Change frame which contains UHR NPCA Request field may be referred as an NPCA Request frame. A UHR Dynamic Operating Mode Change frame which contains UHR NPCA Response field may be referred as an NPCA Response frame. A UHR Dynamic Operating Mode Change frame which contains UHR DSO Request field may be referred as a DSO Request frame. A UHR Dynamic Operating Mode Change frame which contains UHR DSO Response field may be referred as a DSO Response frame. A UHR Dynamic Operating Mode Change frame which contains UHR Coexistence Request field may be referred as a Coexistence Request frame. A UHR Dynamic Operating Mode Change frame which contains UHR Coexistence Response field may be referred as a Coexistence Response frame. A UHR Dynamic Operating Mode Change frame which contains UHR DPP Request field may be referred as a DPP Request frame. A UHR Dynamic Operating Mode Change frame which contains UHR DPP Response field may be referred as a DPP Response frame.

The Category field may indicate this is a UHR Action frame or Protected UHR Action frame. The UHR Action field may be defined as shown in Table 6. Note that Value 0 may indicate it is a UHR Dynamic Operating Mode Change frame and the UHR Mode Control field may be always present. The format of the UHR Mode Control field is shown in Table 8.

TABLE 8
UHR Mode Control field format

| | | | |
|---|---|---|---|
| Mode Type | Mode Class | DMC Role | Status Code |

The Mode Type subfield in the UHR Mode Control field as illustrated in Table 8 may indicate the mode type as defined in Table 9.

TABLE 9
Mode type Subfield

| Value | Meaning |
|---|---|
| 0 | Power Saving Mode |
| 1 | NPCA Mode |
| 2 | DSO Mode |
| 3 | Coexistence Mode |
| 4 | Dynamic Preamble Puncturing Mode |

With continued reference to Table 8, we note that the Mode Class subfield may indicate a mode changing procedure that may follow class 1, class 2, or class 3 as previously described in this disclosure. The DMC Role subfield may indicate if the STA which transmits the frame is a DMC initiator or responder and the number of DMC responders evolved. The exemplary DMC Role subfield format was shown previously in Table 5 and the explanation of the use of the subfield is given in accompanying text.

The Status Code subfield may indicate the status of the mode change. It may be set to values SUGGEST, DICTATE, SUCCESS, DECLINED, SUGGESTED_PARAMETERS etc. The Status Code subfield may be reserved in certain some cases. In one example, when the Mode Type subfield is set to NPCA, Coexistence, it may be reserved.

An intended receiving STA may use the information carried in the Mode type and/or the Mode Class and/or the DMC Role subfield to determine the presence of the field following the UHR Mode Control field. In another word, the presence of UHR Power Saving Request field, UHR Power Saving Response field, UHR NPCA Request field, UHR NPCA Response field, UHR DSO Request field, UHR DSO Response field, UHR Coexistence Request field, UHR coexistence Response field, UHR Dynamic Preamble Puncturing Request field, UHR Dynamic Preamble Puncturing Response field may depend on the settings in the Mode type subfield and/or the Mode Class subfield and/or whether it is the DMC initiator/responder. For example, when Mode type indicates Power Saving, and the DMC Role indicates DMC initiator then UHR Power Saving Request field may present.

### Power Saving Request Field

The Power Saving Request field may be defined as illustratively shown in Table 10 and it may include a Common Info subfield and a User List subfield.

TABLE 10
Power Saving Request field format

| | |
|---|---|
| Common Info/DMC Initiator | User/DMC Responder List |

The Common/DMC Initiator Info subfield may be defined as illustratively shown in Table 11. The Common/DMC Initiator Info subfield may carry operating parameters of the TXOP initiator/the DMC initiator/transmitter of the Power Saving Request frame within the upcoming TXOP or service period. Note that while we use the terminology “DMC initiator”, it may be replaced by “TXOP initiator” or “transmitter of the Power Saving Request frame”.

The Max Rx NSS subfield may indicate the maximum number of receive spatial streams the DMC initiator may be able to use in the upcoming TXOP/service period.

The Max Tx NSS subfield may indicate the maximum number of transmit spatial streams the DMC initiator may be able to use in the upcoming TXOP/service period.

The Max MCS subfield may indicate the highest MCS order the DMC initiator may use to transmit and receive in the upcoming TXOP/service period. In one method, a Max Tx MCS subfield and a Max Rx MCS subfield may be defined to indicate the highest MCS order the DMC initiator may use to transmit and receive in the upcoming TXOP/service period respectively.

The Channel Width subfield may indicate the channel width/bandwidth the DMC initiator may be able to use in the upcoming TXOP/service period. For example, the Channel Width subfield may indicate 20 MHz, 40 MHz, 80 MHz, 160 MHz, 320 MHz channel width.

The Dynamic Puncturing Disable subfield may indicate whether the dynamic puncturing may be allowed or suggested in the upcoming TXOP/service period. Here dynamic puncturing means puncturing additional subchannels not indicated by the Disabled Subchannel Bitmap.

The DRU Disable subfield may indicate whether the distributed RU allocation may be allowed or suggested in the upcoming TXOP/service period.

The UL MU Disable subfield may indicate whether the UL trigger-based transmissions (i.e., including uplink control frame and data frame) may be allowed or suggested in the upcoming TXOP/service period.

The UL Data MU Disabled subfield indicate whether the UL trigger-based data transmissions (i.e., data frame) may be allowed or suggested in the upcoming TXOP/service period.

QoS Info subfield may indicate the QoS parameters (e.g., Access Category, or TID, Delay Bound etc) or threshold allowed/valid to transmit/receive in the TXOP when the DMC initiator or responder is under the new mode.

In one illustrative method, the fields carried in Trigger frame may be carried here to assign uplink transmission parameters. For example, UL Length, UL BW, GI And LTF Type, Number of LTF Symbols, AP Tx Power, Pre-FEC Padding Factor, PE Disambiguity, UL Spatial Reuse, U-SIG Reserved, P160, UL MCS, UL Target Receive Power subfields etc. Some of the above-mentioned subfields may be included in the Common/DMC Initiator field and some subfields may be included in the User/DMC Responder List field. A More ICF subfield may also need to be included to indicate if more ICF frame may be included in the TXOP.

TABLE 11
Common Info/DMC Initiator subfield field
format in the Power Saving Request field

| | | | | | | | |
|---|---|---|---|---|---|---|---|
| Max | Max | Max | Channel | Preamble | DRU | QoS | Reserved |
| Rx | Tx | MCS | Width | Puncturing | Disabled | Info | |
| Nss | NSS | | | | | | |

The User/DMC Responder List subfield may carry zero or more User Info subfields. In one illustrative method, the User/DMC Responder List subfield may not be present if the DMC initiator is a non-AP STA (e.g., uplink transmission from a non-AP STA). In that case, the Common/DMC Initiator Info subfield may be present and indicate the operating parameter of the non-AP STA. In another illustrative method, the User/DMC Responder List subfield may not be present if the DMC initiator knows the capabilities of the DMC responder(s) and sets the operating parameters in the Common Info field under the DMC responder(s)'s capabilities.

The User/DMC Responder List subfield may carry one (or at least one) User/DMC Responder Info subfield if the Power Saving Request/Response transmission may be a one-to-one transmission either in downlink or uplink. The User/DMC Responder List subfield may carry more than one User Info subfield if the Power Saving Request/Response transmission may be a one to multiple transmission, i.e., the Power Saving Request may be a multicast transmission.

Each User/DMC Responder Info subfield may carry the requested/suggested operating parameters of the TXOP responder/the DMC responder within the upcoming TXOP or service period by the DMC initiator. The User/DMC Responder Info subfield format is given in Table 12.

TABLE 12
User/DMC Responder Info subfield format

| | | | | | |
|---|---|---|---|---|---|
| AID | Max Rx | Max Tx | Max MCS | Channel | Preamble |
| | Nss | NSS | | Width | Puncturing |
| DRU | UL MU | UL MU | RU | QoS Info | Reserved |
| Disabled | Disabled | Data | Allocation | | |
| | | Disabled | | | |

The AID subfield may be used to indicate the STA ID, i.e., the DMC responder ID. An AP may also have an AID which may be used when the AP is the DMC responder. The AP may announce its own AID in its management frame such as Beacon frame, (Re) Association Response frame, Probe Response frame etc.

The Max Rx NSS subfield may indicate the maximum number of receive spatial streams the DMC initiator may suggest/request the DMC responder corresponding to the AID to use in the upcoming TXOP/service period.

The Max Tx NSS subfield may indicate the maximum number of transmit spatial streams the DMC initiator may suggest/request the DMC responder corresponding to the AID to use in the upcoming TXOP/service period.

The Max MCS subfield may indicate the highest MCS order the DMC initiator may suggest/request the DMC responder corresponding to the AID to use to transmit and receive in the upcoming TXOP/service period. In one method, a Max Tx MCS subfield and a Max Rx MCS subfield may be defined to indicate the highest MCS order to use to transmit and receive in the upcoming TXOP/service period respectively.

The Channel Width subfield may indicate the channel width/bandwidth the DMC initiator may suggest/request the DMC responder corresponding to the AID to use in the upcoming TXOP/service period. For example, the Channel Width subfield may indicate 20 MHz, 40 MHz, 80 MHz, 160 MHz, 320 MHz channel width.

The Dynamic Puncturing Disable subfield may indicate whether the dynamic puncturing may be allowed or suggested in the upcoming TXOP/service period for the DMC responder corresponding to the AID.

The DRU Disable subfield may indicate whether the distributed RU allocations may be allowed or suggested in the upcoming TXOP/service period for the DMC responder corresponding to the AID.

The UL MU Disabled subfield indicate whether the UL trigger-based transmissions (i.e., including uplink control frame and data frame) may be allowed or suggested in the upcoming TXOP/service period for the DMC responder corresponding to the AID.

The UL Data MU Disabled subfield indicate whether the UL trigger-based data transmissions (i.e., data frame) may be allowed or suggested in the upcoming TXOP/service period for the DMC responder corresponding to the AID.

The RU Allocation subfield may indicate the RU(s) and/or subchannel(s) the DMC responder may use to transmit the Power Saving Response frame. In one method, the fields carried in Trigger frame may be carried here to assign uplink transmission parameters. For example, UL Length, UL BW, GI And LTF Type, Number of LTF Symbols, AP Tx Power, Pre-FEC Padding Factor, PE Disambiguity, UL Spatial Reuse, U-SIG Reserved, P160, UL MCS, UL Target Receive Power subfields etc. Some of the above-mentioned subfields may be included in the Common/DMC Initiator field and some subfields may be included in the User/DMC Responder List field. A More ICF subfield may also need to be included to indicate if more ICF frame may be included in the TXOP.

The QoS Info subfield may indicate the QoS parameters (e.g., Access Category, or TID, Delay Bound etc.) or threshold allowed/valid to transmit/receive in the TXOP when the DMC initiator or responder is under the new mode.

In one illustrative method, the AID field of a User Info field may be set to a particular value (e.g., 0) which is not assigned to any STA (e.g., non-AP STA) to indicate the operating parameters carried in the User/DMC Responder Info field may be the request or suggestion to all STAs but not a particular one.

The User Info field may carry one or more special User/DMC Responder Info fields. The special User/DMC Responder Info fields may start with an unassigned AID value and serve to a particular purpose depending on the AID value. For example, AID value k and above may not be assigned to any STAs. The User/DMC Responder Info field with AID subfield set to AID value k may indicate the subfield may carry padding information. The User/DMC Responder Info field with AID subfield set to AID value k+1 may indicate the subfield may carry an FCS or an additional FCS. In one method, one or more special User/DMC Responder fields which carries the padding bits may be placed after the special User/DMC Responder field which carries the FCS.

### Power Saving Response Field

### Option I

The Power Saving Response field may have the same format as the Power Saving Request field.

The Common/DMC Initiator Info subfield may confirm the operating parameters of the TXOP initiator/the DMC initiator or the TXOP responder/DMC responder within the upcoming TXOP or service period depending on whether the User List is carried in the Power Saving Request frame that solicit the Power Saving Response frame.

The User/DMC Responder List subfield may include zero or one or more User/DMC Responder Info subfields. The User/DMC Responder Info subfield may carry the operating parameters of the TXOP responder/the DMC responder within the upcoming TXOP or service period.

If the Power Saving Request frame that solicited the transmission of the Power Saving Response frame contains at least one User Info subfield that addressed to a STA, the Power Saving Response frame may carry the Common/DMC Initiator Info and User/DMC Responder List subfield. The Common/DMC Initiator Info subfield may confirm the operating parameters of the TXOP initiator/the DMC initiator within the upcoming TXOP or service period. The User/DMC Responder List subfield may contain one or more User/DMC Responder Info subfield.

In one illustrative method, the DMC responder may choose a set of operating parameters which are different from the requested/suggested operating parameters set by the DMC initiator. In another illustrative method, the DMC responder may use the same set of operating parameters which are requested/suggested by the DMC initiator to set the User/DMC Responder Info subfield.

In still another illustrative method, the DMC responder may choose a set of operating parameters which are limited by the requested/suggested operating parameters set by the DMC initiator to set the User/DMC Responder Info subfield.

For example, the Max Rx Nss, Max Tx NSS, Max MCS and Channel Width chosen by the DMC responder may be smaller than to or equal to that set by the DMC initiator. The DMC responder may change Dynamic Puncturing Disable subfield, DRU Disable subfield, UL MU Disabled subfield UL Data MU Disabled subfield from false to true (i.e., from enabled to disabled).

### Option II

In one illustrative method, the Power Saving Response frame may only carry a DMC Responder Info subfield. For example, if the Power Saving Request frame that solicited the transmission of the Power Saving Response frame may not contain User Info subfield that addressed to a STA (e.g., the Power Saving Request was transmitted by a non-AP STA in uplink), the Power Saving Response frame may contain DMC Responder Info field only. The DMC Responder Info subfield carried in the Power Saving Response frame may follow the rules below. In one method, the DMC responder may use the same set of operating parameters which are carried in the Common/DMC Initiator Info field of the Power Saving Request frame. In one method, the DMC responder may choose a set of operating parameters which are limited by the operating parameters carried in the Common/DMC Initiator Info field of the Power Saving Request frame transmitted by the DMC initiator. For example, the Max Rx Nss, Max Tx NSS, Max MCS and Channel Width chosen by the DMC responder may be smaller than to or equal to that set in the Common/DMC Initiator Info field of the Power Saving Request frame by the DMC initiator. The DMC responder may change Dynamic Puncturing Disable subfield, DRU Disable subfield, UL MU Disabled subfield UL Data MU Disabled subfield from false to true (i.e., from enabled to disabled).

### Option III

In one illustrative method, the Power Saving Response frame may be used to acknowledge the reception of the Power Saving Request frame. In another illustrative method, the MAC frame of the Power Saving Response frame may be set to the same values so that the potential overlapping transmissions of the frame from more than one DMC responders may be exactly the same and decodable by the DMC initiator. In this way, the DMC responders' MAC addresses and IDs (e.g., AID) may NOT be carried in the Power Saving Response frame. In one method, CTS frame or a frame with similar frame format as the CTS frame may be used as the Power Saving Response frame.

In yet another illustrative method, the Power Saving Response frame may carry limited DMC responder related information such the DMC responder MAC address/ID etc.

### Non-Primary Channel Access (NPCA) Request Field

In one illustrative embodiment, the NPCA Request field may be defined as illustratively shown in Table 13 and it may include two fields, namely a Common Info/DMC Initiator subfield and User/DMC Responder List subfield.

TABLE 13
NPCA Request field format

| | |
|---|---|
| Common Info/DMC Initiator | User/DMC Responder List |

The Common/DMC Initiator Info subfield may be defined as illustratively shown in Table 14. The Common/DMC Initiator Info subfield may carry operating parameters of the TXOP initiator/the DMC initiator/transmitter of the NPCA Request frame within the upcoming TXOP or service period. Note, below we may use the terminology “DMC initiator”, but it may be replaced by “TXOP initiator” or “transmitter of the NPCA Request frame”.

TABLE 14
Common Info/DMC Initiator subfield format in the NPCA Request field

| | | | | | | | | | |
|---|---|---|---|---|---|---|---|---|---|
| Time To | Dynamic | DRU | MLO | NAV | QoS | UL MU | UL Data | NPCA | Reserved |
| Stay | Puncturing | Disabled | Disabled | Duration | Info | Disabled | MU | Secondary | |
| in the | Disabled | | | Threshold | | | Disabled | Subchannel | |
| NPCA | | | | | | | | | |

The fields of the Common Info/DMC Initiator subfield format in the NPCA Request field are illustratively defined as follows.

Time To Stay in the NPCA: this subfield may indicate the maximum or minimum time that the DMC initiator and DMC responder(s) will stay in the non-primary channel before switching back to the primary channel.

Dynamic Puncturing Disabled: this subfield may indicate whether the dynamic puncturing may be allowed or suggested in the upcoming TXOP/service period on the non-primary channel. In one method, a Dynamic Puncturing Info field may be included in the Common Info/DMC Initiator subfield to indicate the subchannels punctured over the NPCA transmissions.

DRU Disabled: this subfield may indicate whether the distributed RU allocation may be allowed or suggested in the upcoming TXOP/service period on the non-primary channel.

MLO Disabled: this subfield may indicate whether the multilink operation (MLO) is allowed or suggested in the upcoming TXOP/service period on the non-primary channel.

NAV Duration Threshold: This subfield may indicate the NAV duration threshold for the basic NAV for which switching to the non-primary channel is allowed. This field may enable the dynamic change of this threshold.

QoS Info: this subfield may indicate the QoS parameters (e.g., Access Category, or TID, Delay Bound etc) or threshold allowed/valid to transmit/receive in the TXOP when the DMC initiator or responder is on the non-primary channel.

UL MU Disable: this subfield may indicate whether the UL trigger-based transmissions (i.e., including uplink control frame and data frame) may be allowed or suggested in the upcoming TXOP/service period on the non-primary channel.

UL Data MU Disabled: this subfield may indicate whether the UL trigger-based data transmissions (i.e., data frame) may be allowed or suggested in the upcoming TXOP/service period on the non-primary channel.

NPCA Secondary Subchannel: this subfield may indicate the location of the secondary subchannel relative to the NPCA primary channel. The NPCA Secondary Subchannel format may be defined as shown in Table 15.

TABLE 15
Exemplary NPCA Secondary Subchannel format

| NPCA | NPCA | NPCA | NPCA |
|---|---|---|---|
| Secondary | Secondary | Secondary | Secondary |
| 20 MHz | 40 | 80 | 160 |

The NPCA Secondary 20 MHz subfield may be set to 0 to indicate the 20 MHz subchannel adjacent to the NPCA primary channel (i.e., the primary 20 MHz subchannel work as the primary channel for NPCA operation) with channel number greater than the NPCA primary 20 MHz channel and set to 1 to indicate the 20 MHz subchannel adjacent to the NPCA primary channel with channel number less than the NPCA primary 20 MHz channel. The subfield may be reserved if the operating bandwidth on the NPCA mode is set to 20 MH. The NPCA primary channel may be used to transmit a 20 MHz PPDU in the NPCA mode. The NPCA primary 40 MHz channel is defined as the union of the NPCA Primary channel and NPCA secondary 20 MHz together. The NPCA primary 40 MHz channel may be used to transmit a 40 MHz PPDU in the NPCA mode.

The NPCA Secondary 40 MHz subfield may be set to 0 to indicate the 40 MHz subchannel adjacent to the NPCA primary 40 MHz channel with channel number greater than the NPCA primary 40 MHz channel and set to 1 to indicate the 40 MHz subchannel adjacent to the NPCA primary 40 MHz channel with channel number less than the NPCA primary 40 MHz channel. The subfield may be reserved if the operating bandwidth on the NPCA mode is set to 20 MH or 40 MHz. The NPCA primary 80 MHz channel is defined as the union of the NPCA Primary 40 MHz channel and NPCA secondary 40 MHz together. The NPCA primary 80 MHz channel may be used to transmit a 80 MHz PPDU in the NPCA mode.

The NPCA Secondary 80 MHz subfield may be set to 0 to indicate the 80 MHz subchannel adjacent to the NPCA primary 80 MHz channel with channel number greater than the NPCA primary 80 MHz channel and set to 1 to indicate the 80 MHz subchannel adjacent to the NPCA primary 80 MHz channel with channel number less than the NPCA primary 80 MHz channel. The subfield may be reserved if the operating bandwidth on the NPCA mode is set to 20 MH, 40 MHz or 80 MHz. The NPCA primary 160 MHz channel is defined as the union of the NPCA Primary 80 MHz channel and NPCA secondary 80 MHz together. The NPCA primary 160 MHz channel may be used to transmit a 160 MHz PPDU in the NPCA mode.

The NPCA Secondary 160 MHz subfield may be set to 0 to indicate the 160 MHz subchannel adjacent to the NPCA primary 160 MHz channel with channel number greater than the NPCA primary 160 MHz channel and set to 1 to indicate the 160 MHz subchannel adjacent to the NPCA primary 160 MHz channel with channel number less than the NPCA primary 160 MHz channel. The subfield may be reserved if the operating bandwidth on the NPCA mode is set to 20 MH, 40 MHz, 80 MHz or 160 MHz. The NPCA primary 320 MHz channel is defined as the union of the NPCA Primary 160 MHz channel and NPCA secondary 160 MHz together. The NPCA primary 320 MHz channel may be used to transmit a 320 MHz PPDU in the NPCA mode.

In one method, the NPCA operating bandwidth in the TXOP may be explicitly signaled in the Common Info/DMC Initiator subfield and/or User Info/DMC Responder subfield. In one method, the NPCA operating bandwidth in the TXOP may be carried in the PPDU, e.g., BW field of the USIG field or the scrambling sequence of a non-HT or non-HT duplicate PPDU with bandwidth signaling TA.

The User/DMC Responder List subfield may carry zero or more User Info subfields. In one method, the User/DMC Responder List subfield may not present if the DMC initiator may be a non-AP STA (e.g., the NPCA Request is sent from a non-AP STA). In that case, the Common/DMC Initiator Info subfield may present and indicate the operating parameter of the non-AP STA. In one method, the User/DMC Responder List subfield may not present if the DMC initiator knows the capabilities of the DMC responder(s) and set the operating parameters in the Common Info field under the DMC responder(s)'s capabilities.

The User/DMC Responder List subfield may carry one (or at least one) User/DMC Responder Info subfield if the NPCA Request/Response transmission may be a one-to-one transmission either in downlink or uplink. The User/DMC Responder List subfield may carry more than one User Info subfield if the NPCA Request/Response transmission may be a one to multiple transmission, i.e., the NPCA Request may be a multicast transmission.

Each User/DMC Responder Info subfield may carry the requested/suggested operating parameters of the TXOP responder/the DMC responder within the upcoming TXOP or service period by the DMC initiator. The User/DMC Responder Info subfield format is illustratively given in Table 16

TABLE 16
User Info subfield format in User/DMC Responder List in the NPCA Request

| | | | | | | | | | |
|---|---|---|---|---|---|---|---|---|---|
| AID | RU | Time To | Dynamic | DRU | MLO | NAV | QoS | UL MU | UL Data |
| | Allocation | Stay | Puncturing | Disabled | Disabled | Duration | Info | Disabled | MU |
| | | in the | Disabled | | | Threshold | | | Disabled |
| | | NPCA | | | | | | | |

The fields of User Info subfield in User/DMC Responder List in the NPCA Request are defined as follows.

AID: this field may be used to indicate the STA ID, i.e., the DMC responder ID. An AP may also have an AID which may be used when the AP is the DMC responder. The AP may announce its own AID in its management frame such as Beacon frame, (Re) Association Response frame, Probe Response frame etc.

RU Allocation: this field may indicate the RU(s) and/or subchannel(s) the DMC responder may use to transmit the NPCA Response frame. In one method, the fields carried in Trigger frame may be carried here to assign uplink transmission parameters. For example, UL Length, UL BW, GI And LTF Type, Number of LTF Symbols, AP Tx Power, Pre-FEC Padding Factor, PE Disambiguity, UL Spatial Reuse, U-SIG Reserved, P160, UL MCS, UL Target Receive Power subfields etc. Some of the above-mentioned subfields may be included in the Common/DMC Initiator field and some subfields may be included in the User/DMC Responder List field. More ICF subfield may also need to be included to indicate if more ICF frame may be included in the TXOP.

Time To Stay in the NPCA: this field may indicate the maximum time that the DMC initiator may suggest/request the DMC responder(s) corresponding to the AID to stay in the non-primary channel before switching back to the primary channel.

Dynamic Puncturing Disabled: this field may indicate whether the dynamic puncturing may be allowed or suggested in the upcoming TXOP/service period on the non-primary channel for the DMC responder corresponding to the AID.

DRU Disabled: this field may indicate whether the distributed RU allocation may be allowed or suggested in the upcoming TXOP/service period on the non-primary channel for the DMC responder corresponding to the AID.

MLO Disabled: this field may indicate whether the multilink operation (MLO) is allowed or suggested in the upcoming TXOP/service period on the non-primary channel for the DMC responder corresponding to the AID.

NAV Duration Threshold: This field may indicate the NAV duration threshold for the basic NAV for which switching to the non-primary channel is allowed for the DMC responder corresponding to the AID. This field may enable the dynamic change of this threshold.

QoS Info: this field may indicate the QoS parameters (e.g., Access Category, or TID, Delay Bound etc) or threshold allowed/valid to transmit/receive in the TXOP when the DMC initiator or responder is on the non-primary channel for the DMC responder corresponding to the AID.

UL MU Disable: this field may indicate whether the UL trigger-based transmissions (i.e., including uplink control frame and data frame) may be allowed or suggested in the upcoming TXOP/service period on the non-primary channel for the DMC responder corresponding to the AID.

UL Data MU Disabled: subfield indicate whether the UL trigger-based data transmissions (i.e., data frame) may be allowed or suggested in the upcoming TXOP/service period on the non-primary channel for the DMC responder corresponding to the AID.

### NPCA Response Field

### Option I

The NPCA Response field may have the same format as the NPCA Request field.

The Common/DMC Initiator Info subfield may be used to confirm the operating parameters of the TXOP initiator/the DMC initiator or the TXOP responder/DMC responder within the upcoming TXOP or service period depending on whether the User List is carried in the NPCA Request frame that solicit the NPCA Response frame.

The User/DMC Responder List subfield may carry zero, one or more User/DMC Responder Info subfields. The User/DMC Responder Info subfield may carry the operating parameters of the TXOP responder/the DMC responder within the upcoming TXOP or service period.

If the NPCA Request frame that solicited the transmission of the NPCA Response frame contains at least one User Info subfield that is addressed to a STA, The NPCA Response frame may carry the Common/DMC Initiator Info and User/DMC Responder List subfield. The Common/DMC Initiator Info subfield may confirm the operating parameters of the TXOP initiator/the DMC initiator within the upcoming TXOP or service period. The User/DMC Responder List subfield may contain one or more User/DMC Responder Info subfield. In one method, the DMC responder may choose a set of operating parameters which are different from the requested/suggested operating parameters set by the DMC initiator. In one method, the DMC responder may use the same set of operating parameters which are requested/suggested by the DMC initiator to set the User/DMC Responder Info subfield. In one method, the DMC responder may choose a set of operating parameters which are limited by the requested/suggested operating parameters set by the DMC initiator to set the User/DMC Responder Info subfield. For example, the Time To Stay in the NPCA, the NAV Duration and NPCA Secondary Subchannel chosen by the DMC responder may be smaller than to or equal to that set by the DMC initiator. The DMC responder may change Dynamic Puncturing Disable subfield, DRU Disable subfield, UL MU Disabled subfield UL Data MU Disabled subfield from false to true (i.e., from enabled to disabled).

### Option II

In one illustrative method, the NPCA Response frame may only carry a DMC Responder Info subfield. For example, if the NPCA Request frame that solicited the transmission of the NPCA Response frame may not contain User Info subfield that addressed to a STA (e.g., the NPCA Request was transmitted by a non-AP STA in the uplink), the NPCA Response frame may contain DMC Responder Info field only. The DMC Responder Info subfield carried in the NPCA Response frame may follow the rules described below.

In another illustrative method, the DMC responder may use the same set of operating parameters which are carried in the Common/DMC Initiator Info field of the NPCA Request frame. In yet another illustrative method, the DMC responder may choose a set of operating parameters which are limited by the operating parameters carried in the Common/DMC Initiator Info field of the NPCA Request frame transmitted by the DMC initiator. For example, the Time To Stay in the NPCA, the NAV Duration and NPCA Secondary Subchannel chosen by the DMC responder may be smaller than to or equal to that set by the DMC initiator. The DMC responder may change Dynamic Puncturing Disable subfield, DRU Disable subfield, UL MU Disabled subfield UL Data MU Disabled subfield from false to true (i.e., from enabled to disabled).

### Option III

In one illustrative method, the NPCA Response frame may be used to acknowledge the reception of the NPCA Request frame.

In another illustrative method, the MAC frame of the NPCA Response frame may be set to the same values so that the potential overlapping transmissions of the frame from more than one DMC responders may be substantially the same and decodable by the DMC initiator. In this way, the DMC responders' MAC addresses and IDs (e.g., AID) may NOT be carried in the NPCA Response frame. In still another illustrative method, a CTS frame, CTS-To-Self or a frame with similar frame format as the CTS frame may be used as the NPCA Response frame.

In yet another illustrative method, the NPCA Response frame may carry limited DMC responder related information such the DMC responder MAC address/ID etc.

Note, the detailed frame format design disclosed here may be used as an example. The frame format may contain more or less than what disclosed here. The frame format may be a combination of one or more frame formats disclosed in the entire document.

### DSO Request Field

In an illustrative embodiment, the DSO Request field may be defined as illustratively shown in Table 17 and it may include two fields, namely, a Common Info/DMC Initiator and a User/DMC Responder List.

TABLE 17
DSO Request field format

| | |
|---|---|
| Common Info/DMC Initiator | User/DMC Responder List |

The Common/DMC Initiator Info subfield may be defined as illustratively shown in Table 18. The Common/DMC Initiator Info subfield may carry operating parameters of the TXOP initiator/the DMC initiator/transmitter of the DSO Request frame within the upcoming TXOP or service period. Note, below we may use the terminology “DMC initiator”, but it may be replaced by “TXOP initiator” or “transmitter of the DSO Request frame”.

TABLE 18
Common Info/DMC Initiator subfield format in the DSO Request field

| | | | | | | | | | |
|---|---|---|---|---|---|---|---|---|---|
| Subchannel | Max | Max | Dynamic | DRU | MLO | QoS | UL MU | UL Data | Reserved |
| Indication | Rx | Tx | Puncturing | Disabled | Disabled | Info | Disabled | MU | |
| | Nss | Nss | Disabled | | | | | Disabled | |

The fields of the Common Info/DMC Initiator subfield format in the DSO Request field are illustratively defined as follows.

Subchannel Indication: this subfield may indicate the subchannel that DMC initiator may be able to use in the upcoming TXOP/service period in the DSO mode. Note the mapping between the logical RU indices and the physical RU locations is determined based on the primary secondary channel locations, and the entire channel bandwidth. In one method, the AP or the DMC initiator may still use the existing mapping between the logical RU indices and the physical RU locations based on the primary channel and entire bandwidth to allocate the resources to the STAs operating on the DSO. In one method, the mapping between the logical RU indices and the physical RU locations may be redefined within the DSO subchannel bandwidth. In this way, the DSO primary channels/secondary channels may need to be defined clearly so the DSO STAs understand the RU Allocation field in either the SIG field or the Trigger frame correctly. An exemplary Subchannel Indication subfield is illustratively shown in Table 19.

TABLE 19
Exemplary DSO Subchannel Indication subfield format

| DSO | DSO | DSO | DSO | DSO |
|---|---|---|---|---|
| Primary | Secondary | Secondary | Secondary | Secondary |
| Channel | 20 MHz | 40 | 80 | 160 |

The DSO Primary Channel subfield may indicate the frequency location of a 20 MHz channel which may be used to transmit a 20 MHz PPDU in the DSO mode. For example, the channel number may be used to indicate frequency location.

The DSO Secondary 20 MHz subfield may indicate the DSO secondary 20 MHz is a 20 MHz subchannel with channel number greater than or less than the DSO primary 20 MHz channel. The subfield may be reserved if the operating bandwidth on the DSO mode is set to 20 MHz. The DSO primary 40 MHz channel is defined as the union of the DSO Primary channel and DSO secondary 20 MHz together. The DSO primary 40 MHz channel may be used to transmit a 40 MHz PPDU in the DSO mode.

The DSO Secondary 40 MHz subfield may indicate the DSO secondary 40 MHz is a 40 MHz subchannel with channel number greater than or less than the DSO primary 40 MHz channel. The subfield may be reserved if the operating bandwidth on the DSO mode is set to 20 MHz, 40 MHz. The DSO primary 80 MHz channel is defined as the union of the DSO Primary 40 MHz channel and DSO secondary 40 MHz together. The DSO primary 80 MHz channel may be used to transmit an 80 MHz PPDU in the DSO mode.

The DSO Secondary 80 MHz subfield may indicate the DSO secondary 80 MHz is an 80 MHz subchannel with channel number greater than or less than the DSO primary 80 MHz channel. The subfield may be reserved if the operating bandwidth on the DSO mode is set to 20 MHz, 40 MHz, 80 MHz. The DSO primary 160 MHz channel is defined as the union of the DSO Primary 80 MHz channel and DSO secondary 80 MHz together. The DSO primary 160 MHz channel may be used to transmit a 160 MHz PPDU in the DSO mode.

The DSO Secondary 160 MHz subfield may indicate the DSO secondary 160 MHz is a 160 MHz subchannel with channel number greater than or less than the DSO primary 160 MHz channel. The subfield may be reserved if the operating bandwidth on the DSO mode is set to 20 MHz, 40 MHz, 80 MHz, 160 MHz. The DSO primary 320 MHz channel is defined as the union of the DSO Primary 160 MHz channel and DSO secondary 160 MHz together. The DSO primary 320 MHz channel may be used to transmit a 320 MHz PPDU in the DSO mode.

Table 20 illustratively shows User Info subfield format in User/DMC Responder Lit DSO Request as follows.

TABLE 20
User Info subfield format in User/DMC Responder List in the DSO Request

| | | | | | | | | | | |
|---|---|---|---|---|---|---|---|---|---|---|
| AID | RU | Subchan | Max | Max | Dynamic | DRU | MLO | QoS | UL MU | UL Data |
| | Alloc. | Ind. | Rx | Tx | Puncturing | Disabled | Disabled | Info | Disabled | MU |
| | | | Nss | Nss | Disabled | | | | | Disabled |

Max Rx NSS: this field may indicate the maximum number of receive spatial streams the DMC initiator may suggest/request the DMC responder corresponding to the AID to use in the upcoming TXOP/service period in the DSO mode.

Max Tx NSS: this field may indicate the maximum number of transmit spatial streams the DMC initiator may suggest/request the DMC responder corresponding to the AID to use in the upcoming TXOP/service period in the DSO mode.

Dynamic Puncturing Disabled: this field may indicate whether the dynamic puncturing may be allowed or suggested in the upcoming TXOP/service period in the DSO mode. In one method, a Dynamic Puncturing Info field may be included in the Common Info/DMC Initiator subfield to indicate the subchannels punctured over the DSO transmissions.

DRU Disabled: this field may indicate whether the distributed RU allocation may be allowed or suggested in the upcoming TXOP/service period in the DSO mode.

MLO Disabled: this field may indicate whether the multilink operation (MLO) is allowed or suggested in the upcoming TXOP/service period in the DSO mode.

QoS Info: this field may indicate the QoS parameters (e.g., Access Category, or TID, Delay Bound etc) or threshold allowed/valid to transmit/receive in the TXOP when the DMC initiator or responder is in the TXOP/service period in the DSO mode.

UL MU Disable: this field may indicate whether the UL trigger-based transmissions (i.e., including uplink control frame and data frame) may be allowed or suggested in the upcoming TXOP/service period in the DSO mode.

UL Data MU Disabled: subfield indicate whether the UL trigger-based data transmissions (i.e., data frame) may be allowed or suggested in the upcoming TXOP/service period in the DSO mode.

The User/DMC Responder List subfield may carry zero or more User Info subfields. In one method, the User/DMC Responder List subfield may not present if the DMC initiator may be a non-AP STA (e.g., the DSO Request is sent from a non-AP STA). In that case, the Common/DMC Initiator Info subfield may present and indicate the operating parameter of the non-AP STA. In one method, the User/DMC Responder List subfield may not present if the DMC initiator knows the capabilities of the DMC responder(s) and set the operating parameters in the Common Info field under the DMC responder(s)'s capabilities.

The User/DMC Responder List subfield may carry one (or at least one) User/DMC Responder Info subfield if the DSO Request/Response transmission may be a one-to-one transmission either in downlink or uplink. The User/DMC Responder List subfield may carry more than one User Info subfield if the DSO Request/Response transmission may be a one to multiple transmission, i.e., the DSO Request may be a multicast transmission.

Each User/DMC Responder Info subfield may carry the requested/suggested operating parameters of the TXOP responder/the DMC responder within the upcoming TXOP or service period by the DMC initiator. The fields of User Info subfield in User/DMC Responder List in the NPCA Request are:

AID: this field may be used to indicate the STA ID, i.e., the DMC responder ID. An AP may also have an AID which may be used when the AP is the DMC responder. The AP may announce its own AID in its management frame such as Beacon frame, (Re) Association Response frame, Probe Response frame etc.

RU Allocation: this field may indicate the RU(s) and/or subchannel(s) the DMC responder may use to transmit the NPCA Response frame. In one method, the fields carried in Trigger frame may be carried here to assign uplink transmission parameters. For example, UL Length, UL BW, GI And LTF Type, Number of LTF Symbols, AP Tx Power, Pre-FEC Padding Factor, PE Disambiguity, UL Spatial Reuse, U-SIG Reserved, P160, UL MCS, UL Target Receive Power subfields etc. Some of the above-mentioned subfields may be included in the Common/DMC Initiator field and some subfields may be included in the User/DMC Responder List field. More ICF subfield may also need to be included to indicate if more ICF frame may be included in the TXOP.

Subchannel Indication: this field may indicate the subchannel that may be suggested in the upcoming TXOP/service period in the DSO mode for the DMC responder corresponding to the AID.

Max Rx NSS: this field may indicate the maximum number of receive spatial streams the DMC initiator may be able to use in the upcoming TXOP/service period in the DSO mode.

Max Tx NSS: this field may indicate the maximum number of transmit spatial streams the DMC initiator may be able to use in the upcoming TXOP/service period in the DSO mode.

Dynamic Puncturing Disabled: this field may indicate whether the dynamic puncturing may be allowed or suggested in the upcoming TXOP/service period on the non-primary channel for the DMC responder corresponding to the AID.

DRU Disabled: this field may indicate whether the distributed RU allocation may be allowed or suggested in the upcoming TXOP/service period on the non-primary channel for the DMC responder corresponding to the AID.

MLO Disabled: this field may indicate whether the multilink operation (MLO) is allowed or suggested in the upcoming TXOP/service period on the non-primary channel for the DMC responder corresponding to the AID.

NAV Duration Threshold: This field may indicate the NAV duration threshold.

QoS Info: this field may indicate the QoS parameters (e.g., Access Category, or TID, Delay Bound etc) or threshold allowed/valid to transmit/receive in the TXOP when the DMC initiator or responder is on the non-primary channel for the DMC responder corresponding to the AID.

UL MU Disable: this field may indicate whether the UL trigger-based transmissions (i.e., including uplink control frame and data frame) may be allowed or suggested in the upcoming TXOP/service period on the non-primary channel for the DMC responder corresponding to the AID.

UL Data MU Disabled: subfield indicate whether the UL trigger-based data transmissions (i.e., data frame) may be allowed or suggested in the upcoming TXOP/service period on the non-primary channel for the DMC responder corresponding to the AID.

### DSO Response Field

### Coexistence Request Field

The coexistence interference event may be a in-device transmission/reception that may introduce interference to the transmission and reception of the WiFi radio on a WiFi channel. The coexistence interference may be a non-WiFi signal or a WiFi signal which may be predictable.

The purpose of the Coexistence Request frame may be used to: Inform its intended receiving STA(s) that the coexistence interference event may be expected if any; and solicit and check if any intended STA/associated STA may have expected any coexistence interference event.

The Coexistence Request frame may carry an explicit or implicit indication whether the Coexistence Request frame may carry DMC Responder's coexistence interference mode information or a simple acknowledgment for the reception of the Coexistence Request frame.

The Coexistence Request field may be defined the same as illustratively shown in Table 21. It may have a Common/DMC Initiator Info subfield and a User/DMC Responder List subfield.

TABLE 21
Common/DMC Initiator Info subfield format
in Coexistence Request/Response field

| | | | | | | | |
|---|---|---|---|---|---|---|---|
| Unavail- | Unavail- | Band- | Channel | Max | Max | DRU | QoS |
| able | able | width | Punc- | Nss | MCS | Dis- | Info |
| Time | Time | | turing | | | abled | |
| Start | Duration | | Info | | | | |

The Common/DMC Initiator Info subfield may be defined as Table 21. The Common/DMC Initiator Info subfield may carry operating parameters of the TXOP initiator/the DMC initiator/transmitter of the Coexistence Request frame for a future TXOP or service period. Note, below we may use the terminology “DMC initiator”, but it may be replaced by “TXOP initiator” or “transmitter of the Coexistence Request frame”.

The Unavailable Time Start subfield may indicate a starting time for the DMC initiator when the coexistence interference event may happen and thus the WiFi transmissions/receptions may need to switch to an In-device coexistence mode. A special value for this subfield may be used to indicate there is no expected/predicted coexistence interference at the moment of the transmission. In one method, when the subfield is set to this value, the rest of the subfields may be reserved. In one method, when the subfield is set to this value, the Unavailable Time Duration subfield may be reserved, and the rest of the subfields may indicate normal operating parameters used in the future.

The Unavailable Time Duration subfield may indicate the time duration the in-device coexistence mode will last.

Bandwidth subfield may indicate the maximum bandwidth of transmissions/receptions when the DMC initiator is under the in-device coexistence mode.

Channel Puncturing Info subfield may indicate the unavailable subchannels for the DMC initiator to transmit/receive when the DMC initiator is under the in-device coexistence mode.

Max NSS subfield may indicate the maximum number of spatial streams of transmissions/receptions when the DMC initiator is under the in-device coexistence mode.

Max MCS subfield may indicate the maximum order of the modulation and coding scheme of transmissions/receptions when the DMC initiator is under the in-device coexistence mode.

DRU Disabled subfield may indicate the if DRU is allowed for transmissions/receptions when the DMC initiator is under the in-device coexistence mode.

QoS Info subfield may indicate the QoS parameters (e.g., Access Category, or TID, Delay Bound etc) or threshold allowed/valid to transmit/receive in the TXOP when the DMC initiator or responder is under the in-device coexistence mode.

Note that we may use a special value of Unavailable Time Start subfield to indicate no expected/predicted interference event in the near future. In an alternative method, a special value of another subfield may be used for the same purpose. In a third method, a subfield (e.g., No Coexistence Event subfield) may be added to the Common/DMC Initiator Info subfield to explicitly indicate no expected/predicted interference event soon.

In one illustrative method, the fields carried in Trigger frame may be carried here to assign uplink transmission parameters. For example, UL Length, UL BW, GI And LTF Type, Number of LTF Symbols, AP Tx Power, Pre-FEC Padding Factor, PE Disambiguity, UL Spatial Reuse, U-SIG Reserved, P160, UL MCS, UL Target Receive Power subfields etc. Some of the above-mentioned subfields may be included in the Common/DMC Initiator field and some subfields may be included in the User/DMC Responder List field. Additional ICF subfields may also need to be included to indicate if more ICF frames are to be included in the TXOP.

With the coexistence mode change case, the DMC initiator may not know if the DMC responder may expect any coexistence interference event. As a result, the DMC initiator may not be able to include any mode change related parameters in the User/DMC Responder List field. The User/DMC Responder List field may be used to carry necessary information for the DMC responder to align their UL transmission. For example, it may carry the same information as that carried in the User Info field in a Trigger frame. In one method, the QoS Info subfield may be carried in the User DMC Responder Info field to indicate the suggested/requested QoS types that may be feasible to transmit/receive by the DMC Responder during the coexistence event. In this way, each DMC responder may have its specific QoS types.

### Coexistence Response Field

The purpose of the Coexistence Response frame may be to Respond to the ICF and inform its intended receiving STA(s) (e.g., the DMC initiator) that the coexistence interference event may or may not be expected. In one illustrative method, the Coexistence Response field may carry a User/DMC Responder Info subfield. The format of the User/DMC Responder Info field may be the same as that defined for Common/DMC Initiator Info subfield as shown in Table 21.

In another illustrative method, the Coexistence Response frame may serve as an acknowledgement of the reception of the Coexistence Request frame. For example, the Coexistence Response frame may use the ACK frame format.

### DPP Request/Response Procedure and Signaling

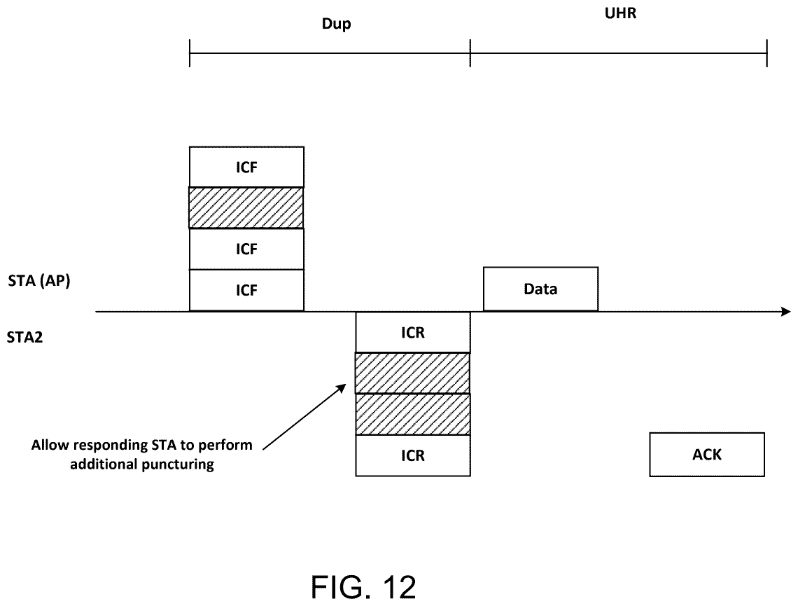

FIG. 12 shows illustrative exemplary procedure of using ICF/ICR to allow dynamic preamble puncturing according to aspects of the present disclosure. As shown in that figure, a DMC initiator (e.g., STA1) may transmit a DPP Request frame (ICF) using non-HT Duplicate PPDU on the available 20 MHz subchannels including the primary 20 MHz subchannel. Upon reception of the DDP Request frame, a DMC responder may check its available 20 MHz subchannels within its operating channel. The DMC responder may transmit the DPP Response frame (ICR) using non-HT Duplicate PPDU or TB PPDU on the available 20 MHz subchannels or assigned subchannels/RUs.

In one illustrative method, the ICF/ICR frame (i.e., DPP Request frame/DPP Response frame) exchange may indicate the dynamic puncturing may be allowed in the upcoming TXOP. The detailed dynamic puncturing information may be carried in the U-SIG fields in the EHT/UHR/UHR+ PPDU in the TXOP. After the ICF/ICR exchange, the DMC initiator and/or responder(s) may open the transmit/receive bandwidth to the operating channel width of the TXOP or switch the center frequency to the assigned subchannel(s) with assigned bandwidth indicated in the ICF/ICR to receive the Punctured Channel Information fields carried in the U-SIG fields on the subchannels. Note one or more Punctured Channel Information fields may be obtained by a receiving STA which may carry one or more dynamic punctured patterns on each subchannel block (e.g., the subchannel block may be a 80 MHz subchannel block). In this way, the receiving STA (e.g., the DMC responder) may know the dynamic puncture patterns on its operating channel(s).

In another illustrative method, the dynamic puncturing information may be carried explicitly in the ICF/ICR. In this way, the DMC initiator and DMC responders may indicate their dynamically punctured channels. And thus, the DMC initiator and responders may be ready to transmit and receive on the subchannel set calculated using below method. We refer A as the available 20 MHz subchannel set of the DMC initiator and Bₖ as the available 20 MHz subchannel set of the DMC responder k. k may be from 1 to K where K is the total number of responders. Then the available 20 MHz subchannel set for the DMC initiator to use is S=A∩(U_{K=1}^{K} Bₖ), and the available 20 MHz subchannel set for the DMC responder k is Sₖ=A∩Bₖ. The DMC initiator may use assign RUs in Sₖ for the DMC responder k.

### DPP Request/Response Field

In one illustrative method, the DPP Request/Response field may use the same format as that shown in the Power Saving Request/Response field. In another illustrative method, the subfields carried in the DPP Request/Response field may be a subset of that carried in the Power Saving Request/Response field. In one method, the Preamble Puncturing field carried in the Common/DMC Initiator field and/or User/DMC Responder field may indicate if following TXOP may allow DPP. In still another illustrative method, the Preamble Puncturing field carried in the Common/DMC Initiator field and/or User/DMC Responder field may indicate the detailed dynamic preamble puncturing information. For example, a bitmap may be used to indicate which 20 MHz/40 MHz subchannels are punctured (not available to transmit/receive).

### Alternative Dynamic Operation Mode Action Frame

In an illustrative alternative method, the UHR Dynamic Operating Mode Change frame format may be defined as illustratively shown in Table 22. The UHR Mode Control field may be as illustratively defined in Table 8. The UHR Mode Change Request field may be a combination of all subfields defined in the Power Saving Request field, the NPCA Request field, the DSO Request field, the Coexistence Request field and the DPP Request field. The UHR Mode Change Response field may be a combination of all subfields defined in the Power Saving Response field, the NPCA Response field, the DSO Response field, the Coexistence Response field and the DPP Response field.

TABLE 22
UHR Dynamic Operating Mode Change frame format

| Order | Meaning |
|---|---|
| 1 | Category |
| 2 | UHR Action |
| 3 | UHR Mode Control |
| 4 | UHR Mode Change Request |
| 5 | UHR Mode Change Response |

Note we use above frame format as examples, the different format may be used. The subfields defined within a subfield/field may be moved to the other subfield/field.

### Dynamic Operating Mode Trigger Frame

Advantageously, an existing HE/EHT Trigger frame may be reused and extended to carry ICF according to aspects of the present disclosure. More particularly, we may refer the extended Trigger frame as enhanced Trigger frame. In some cases, the ICF may be transmitted by a non-AP STA and thus the enhanced Trigger frame may be designed to allow transmission in UL by a non-AP STA. In some cases, the ICF may solicit UL transmissions carried by non-TB PPDU, e.g., non-HT PPDU. The enhanced Trigger frame may be able to allocate resources in the unit of subchannel (e.g., 20 MHz subchannel) and trigger responding frames carried in non-HT PPDUs.

To support ICF Trigger frame transmitted in UL, the AP may need to have an AID. In one method, the AP may assign itself an AID value which has not be assigned to any associated STA. For example, the AID value is greater than 2007. When a non-AP STA transmit an ICF Trigger frame, it may use this AID value in the User Info field.

### New Trigger Frame

In one illustrative method, a UR AP/STA may reuse the EHT/HE variant Trigger frame to convey initial control information for the mode changes. An exemplary EHT/UHR variant Common Info field is illustratively shown in Table 23.

TABLE 23
EHT/UHR Variant Common Info field format of a Trigger frame

| B0 B3 | B4 B15 | B16 | B17 | B18 B19 | B20 B21 | B22 | B23 B25 |
|---|---|---|---|---|---|---|---|
| Trigger | UL | More | CS | UL | GI And | MU-MIMO | Number Of |
| Type | Length/ | TF | Required | BW/BW | EHT-LTE | EHT-LTF | EHT-LTF |
| | Length | | | | Type | Mode | Symbols |
| | | | | | | | And |
| | | | | | | | Midamble |
| | | | | | | | Periodicity |
| 4 | 12 | 1 | 1 | 2 | 2 | 1 | 3 |

| B26 | B27 | B28 B33 | B34 B35 | B36 | B37 B52 | B53 | B54-55 |
|---|---|---|---|---|---|---|---|
| UL | LDPC | AP Tx | Pre-FEC | PE | UL | Doppler | TF |
| STBG | Extra | Power/Tx | Padding | Disam- | Spatial | | Variant |
| | Symbol | Power | Factor | biquity | Reuse | | |
| | Segment | | | | | | |
| 1 | 1 | 6 | 2 | 1 | 16 | 1 | 2 |

| B56 B62 | B63 | |
|---|---|---|
| Reserved | Reserved | Trigger Dependent Common Info |
| 7 | 1 | Variable |

One or more new Trigger types may be defined. For example, Trigger Type subfield is set to value 8 to indicate the Trigger frame may be an ICF for Mode change as shown in Table 24. Mode change here may include but not be limited to power saving mode change, NPCA mode change, DSO mode change, coexistence mode change, DPP mode change etc.

TABLE 24
Encoding of Trigger Type subfield in
the EHT/HE variant Common Info field

| Trigger Type | |
|---|---|
| Subfield value | Trigger frame variant |
| 0 | Basic |
| 1 | BF Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | ICF for Mode Change |
| 9-15 | Reserved |

When the Trigger Type subfield is set to 8, a ICF Trigger may be transmitted in DL or UL. The ICF Trigger frame may be a trigger frame which carries mode change related initial control frame. Whether the ICF transmission is for DL or UL may depend on the Mode Control subfield defined below (e.g., Mode Control subfield in the Trigger Dependent Common Info subfield). Some subfield carried in the EHT/HE variant Common Info field may be reinterpreted. For example:

The UL Length/Length field may indicate the length of the ICR. Note the ICR may be an UL transmission or a DL transmission.

UL_BW/BW field may indicate the bandwidth of the ICF or ICR transmission. In one method, when EHT/EHT+ variant Trigger frame may be used, the UL_BW field and UL Bandwidth Extension field in the Special User Info field together may indicate the bandwidth of the ICF or ICR transmission.

AP Tx Power/Tx Power field may indicate the transmit power of the ICF.

B54 and B55 may form a new field could TF Variant subfield. For example, B54=1 and B55=0 may indicate the transmission of the ICF Trigger frame is from a UHR/UHR+ AP or non-AP STA.

In one illustrative method, the format of the Trigger Dependent Common Info subfield in the HE/EHT variant Common Info field is shown in Table 25.

Mode Control subfield may be defined as Table 8. The detailed explanation of each subfield in the Mode Control subfield is the same as that shown previously.

The Max Rx NSS subfield may indicate the maximum number of receive spatial streams the DMC initiator may be able to use in the upcoming TXOP/service period.

The Max Tx NSS subfield may indicate the maximum number of transmit spatial streams the DMC initiator may be able to use in the upcoming TXOP/service period.

The Max MCS subfield may indicate the highest MCS order the DMC initiator may use to transmit and receive in the upcoming TXOP/service period. In one method, a Max Tx MCS subfield and a Max Rx MCS subfield may be defined to indicate the highest MCS order the DMC initiator may use to transmit and receive in the upcoming TXOP/service period respectively.

The Channel Width subfield may indicate the channel width/bandwidth the DMC initiator may be able to use in the upcoming TXOP/service period. For example, the Channel Width subfield may indicate 20 MHz, 40 MHz, 80 MHz, 160 MHz, 320 MHz channel width.

The Dynamic Puncturing Disable subfield may indicate whether the dynamic puncturing may be allowed or suggested in the upcoming TXOP/service period. Here dynamic puncturing means puncturing additional subchannels not indicated by the Disabled Subchannel Bitmap.

The Preamble Puncturing Info subfield may indicate the unavailable subchannels for the DMC initiator to transmit/receive when the DMC initiator is under the new mode.

The DRU Disable subfield may indicate whether the distributed RU allocation may be allowed or suggested in the upcoming TXOP/service period.

The UL MU Disable subfield may indicate whether the UL trigger-based transmissions (i.e., including uplink control frame and data frame) may be allowed or suggested in the upcoming TXOP/service period.

The UL Data MU Disabled subfield indicate whether the UL trigger-based data transmissions (i.e., data frame) may be allowed or suggested in the upcoming TXOP/service period.

The Unavailable Time Start subfield may indicate a starting time for the DMC initiator when the coexistence interference event may happen and thus the WiFi transmissions/receptions may need to switch to an In-device coexistence mode. A special value for this subfield may be used to indicate there is no expected/predicted coexistence interference at the moment of the transmission. In one method, when the subfield is set to this value, the Unavailable Time Duration subfield may be reserved.

The Unavailable Time Duration subfield may indicate the time duration the in-device coexistence mode will last.

Mode Duration subfield may indicate the maximum or minimum time that the DMC initiator and DMC responder(s) will stay in the new operation mode before switching back to the primary channel.

QoS Info subfield may indicate the QoS parameters (e.g., Access Category, or TID, Delay Bound etc) or threshold allowed/valid to transmit/receive in the TXOP when the DMC initiator or responder is under the new mode.

Subchannel Info subfield may indicate the subchannel(s) that DMC initiator may be able to use in the upcoming TXOP/service period in the new mode. The indicated subchannels may or may not include the primary channel. Normally, RU Allocation field/subfield is used to indicate the RU(s) allocated to a user. The mapping between the logical RU indices and the physical RU locations is determined based on the primary/secondary channel locations, and the entire channel bandwidth. In one method, the AP or the DMC initiator may still use the existing mapping between the logical RU indices and the physical RU locations based on the primary channel and entire bandwidth of mode 1 to allocate the resources to the STAs operating on the new mode (although the primary channel may not always be used in the new mode).

In one illustrative method, the mapping between the logical RU indices and the physical RU locations may be redefined within the new operating mode channel bandwidth. In this way, the second mode primary channels/secondary channels may need to be defined clearly so the STAs understand the RU Allocation field in either the SIG field or the Trigger frame correctly. An exemplary Subchannel Indication subfield is shown in Table 26.

The second mode Primary Channel subfield may indicate the frequency location of a 20 MHz channel which may be used to transmit a 20 MHz PPDU in the second mode. For example, the channel number may be used to indicate frequency location.

The second mode Secondary 20 MHz subfield may indicate the second mode secondary 20 MHz subchannel with channel number greater than or less than the second mode primary 20 MHz channel. The subfield may be reserved if the operating bandwidth on the second mode is set to 20 MHz. The second mode primary 40 MHz channel is defined as the union of the second mode primary channel and second mode secondary 20 MHz together. The second mode primary 40 MHz channel may be used to transmit a 40 MHz PPDU in the second mode.

The second mode Secondary 40 MHz subfield may indicate the second mode secondary 40 MHz subchannel with channel number greater than or less than the second mode primary 40 MHz channel. The subfield may be reserved if the operating bandwidth on the second mode is set to 20 MHz, 40 MHz. The second mode primary 80 MHz channel is defined as the union of the second mode Primary 40 MHz channel and second mode secondary 40 MHz together. The second mode primary 80 MHz channel may be used to transmit an 80 MHz PPDU in the second mode.

The second mode Secondary 80 MHz subfield may indicate the second mode secondary 80 MHz subchannel with channel number greater than or less than the second mode primary 80 MHz channel. The subfield may be reserved if the operating bandwidth on the second mode is set to 20 MHz, 40 MHz, 80 MHz. The second mode primary 160 MHz channel is defined as the union of the second mode Primary 80 MHz channel and second mode secondary 80 MHz together. The second mode primary 160 MHz channel may be used to transmit a 160 MHz PPDU in the second mode.

The second mode Secondary 160 MHz subfield may indicate the second mode secondary 160 MHz subchannel with channel number greater than or less than the second mode primary 160 MHz channel. The subfield may be reserved if the operating bandwidth on the second mode is set to 20 MHz, 40 MHz, 80 MHz, 160 MHz. The second mode primary 320 MHz channel is defined as the union of the second mode Primary 160 MHz channel and second mode secondary 160 MHz together. The second mode primary 320 MHz channel may be used to transmit a 320 MHz PPDU in the second mode.

TABLE 25
Trigger Dependent Common Info field format in EHT/HE variant Common Info field

| | | | | | | | |
|---|---|---|---|---|---|---|---|
| DRUMode | Max Rx | Max Tx | Max MCS | Channel | Dynamic | Preamble | DRU |
| Control | Nss | NSS | | Width | Puncturing | Puncturing | Disabled |
| | | | | | Disabled | | |
| UL MU | UL Data | Unavailable | Unavailable | Mode | Subchannel | QoS Info | Reserved |
| Disable | MU | Time | Time | Duration | Info | | |
| | Disabled | Start | Duration | | | | |

TABLE 26
Exemplary Subchannel Indication subfield format

| Second | Second | Second | Second | Second |
|---|---|---|---|---|
| Mode | Mode | Mode | Mod | Mode |
| Primary | Secondary | Secondary | Secondary | Secondary |
| Channel | 20 MHz | 40 | 80 | 160 |

The Special User Info field in the Trigger frame may use the same format as defined in IEEE P802.11be™/D5.1: Wireless LAN Medium Access Control (MAC) and Physical Layer (PHY) Specifications however, some subfield may be reinterpreted or may be set to new values. The Special User Info field format is illustratively shown in Table 27. Several subfields may be enhanced as follows:

PHY Version ID: PHY Version ID may be set a value greater than 0 to indicate the solicited PPDU is not a EHT TB PPDU. For example, the PHY Version ID may be set to 1 to indicate the solicited PPDU is a UHR TB PPDU or UHR/UHR+ PPDU. The PHY Version ID may be set to 7 to indicate the solicited PPDU is a non-HT PPDU or non-HT Dup PPDU. In the case the solicited PPDU is not a TB PPDU, it is possible the trigger frame is transmitted by a non-AP STA in uplink and the solicited PPDU is transmitted by an AP in downlink. Some subfields in the Common Info field and Special User Info field may be reserved when the PHY Version ID may indicate a value for non-trigger based PPDU. For example, the U-SIG Disregard And Validate subfield may be reserved or served for other purpose if the solicited PPDU is not a trigger based PPDU.

UL Bandwidth Extension: this subfield together with UL BW subfield carried in the Common Info field may indicate the bandwidth of the ICF or solicited ICR when the trigger frame is a ICF Trigger frame.

The Trigger Dependent User Info field carried in the Special User Info field may present and carry some subfields defined in Table 24 in a ICF Trigger frame. The length of the Trigger Dependent User Info field may be predefined, for example one octet or four octets.

TABLE 27
Special User Info field format in the EHT variant Trigger frame

| B0 B11 | B12 B14 | B15 B16 | B17 B20 | B21 B24 | B25 B36 | B37 B39 | |
|---|---|---|---|---|---|---|---|
| AID12 | PHY | UL | Spatial | Spatial | U-SIG | Reserved | Trigger |
| | Version | Bandwidth | Reuse 1 | Reuse 2 | Disregard | | Dependent |
| | ID | Extension | | | And | | User Info |
| | | | | | Validate | | |
| 12 | 3 | 2 | 4 | 4 | 12 | 3 | variable |

Note, the detailed frame format design disclosed here may be used as an example. The frame format may contain more or less than what disclosed here. The frame format may be a combination of one or more frame formats disclosed in the entire document.

### Reusing MU-TRS Trigger Frame

In one illustrative method, a MU-RTS Trigger frame may be modified and used to carry ICF Trigger frame. In this way, the Trigger Type subfield in the Common Info field of the Trigger frame may indicate the MU-RTS trigger type. The MU-RTS Trigger frame which carries the ICF for dynamic mode change may have Common Info field, Special User Info field and one or more User Info fields.

The format of the Common Info field and the Special User Info field may be the same as currently defined IEEE P802.11be/D5.1: Wireless LAN Medium Access Control (MAC) and Physical Layer (PHY) Specifications.

One subfield or a combination of subfields carried in the Common Info field and/or the Special User Info field may be used to indicate the MU-RTS frame may carry ICF information for dynamic mode change. For example, if the PHY Version ID subfield in the Special User Info field is set to a predefined value other than 0, it may indicate the MU-RTS Trigger frame may be a UHR/UHR+ variant MU-RTS Trigger frame, or it may indicate the MU-RTS Trigger frame may carry ICF information. For example, if the HE variant Common Info field is carried in the MU-RTS Trigger frame, and the TXS Mode subfield is set to 3, it may indicate the MU-RTS Trigger frame may carry ICF information.

When the MU-RTS Trigger frame carried the ICF information (we may refer this kind of frame as a MU-RTS ICF Trigger frame), the originally reserved fields, such as UL Length, MU-MIMO HE-LTF Mode, Number of HE-LTF Symbols And Midamble Periodicity, UL STBC, LDPC Extra Symbol Segment, AP Tx Power, Pre-FEC Padding Factor, PE Disambiguity, UL Spatial Reuse and Doppler in the Common Info field may be used to carry some dynamic mode change related information as defined in Table 24. In one method, the UL Length subfield in the Common Info field of the MU-RTS ICF Trigger frame may indicate the value of the L-SIG LENGTH field of the solicited PPDU (e.g., non-HT PPDU).

The User Info field in the MU-RTS ICF Trigger frame may carry AID12 field, RU Allocation field and dynamic mode change related information as defined in Table 24. The AID12 field may indicate the DMC responder AID. The RU Allocation subfield in the User Info field addressed to a DMC responder STA indicates the subchannel or RU on which the ICR is transmitted. In one method, the RU Allocation subfield may assign a subchannel which does not include the Primary channel to a DMC responder. In this way, the ICR may be carried in non-overlapping subchannels/RUs.

In one method, the responding frame of the MU-RTS ICF Trigger frame may be carried in a non-HT PPDU or a non-HT Dup PPDU. The STAs which respond the MU-RTS ICF Trigger frame may be UHR/UHR+ STAs.

In another illustrative method, the ICR frame which solicited by the MU-RTS ICF Trigger frame may be use the CTS frame format.

Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although we used sub-7 GHz link/band to refer a link in MLO system where the control/management frames may be transmitted for mmW link/band, it could be replaced by a more general term such as lower frequency link/band.

Although we define a first field/subfield/element/subelement in a second field/subfield/element/subelement/frame, the first field/subfield/element/subelement may be carried in other fields/subfields/elements/subelements/frames to indicate the same information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A first station (STA) comprising:
a transceiver; and
a processor,
wherein the transceiver and processor are configured to:
receive, from a second STA, an operating mode change control frame including information indicating the first STA change from a first operating mode to second operating mode and information indicating when the first STA changes from the second operating mode back to the first operating mode; and
transmit, to the second STA, a mode change response frame including information indicating status information associated with the information indicating the first STA change from a first operating mode to second operating mode.

2. The first STA of claim 1, wherein the first STA is a non-access point (non-AP) STA, and the second STA is an AP STA.

3. The first STA of claim 1, wherein the information indicating the first STA change from a first operating mode to second operating mode comprises a mode type selected from the group consisting of a power saving (PS) mode, a non-primary channel access (NPCA) mode, a dynamic subchannel operating (DSO) mode, a coexistence mode, and a dynamic preamble puncturing mode.

4. The first STA of claim 1, wherein the information indicating status information comprises a status field selected from the group consisting of:
declined, wherein declined indicates that the first STA declines the change from the first operating mode to the second operating mode;
success, wherein success indicates that the first STA accepts the change from the first operating mode to the second operating mode; and
suggested-parameters, wherein suggested-parameter indicates that the first STA suggests other operating parameters relative to operating parameters received from the second STA in the operating mode change control frame.

5. The first STA of claim 1, wherein the information indicating the first STA change from a first operating mode to second operating mode comprises a mode class selected from the group consisting of class 1, class 2, and class 3.

6. The first STA of claim 5, wherein based on the class 1 mode class, the operating mode change control frame is transmitted from the second STA to the first STA when the second STA is in the first operating mode, and the mode change response frame is transmitted from the first STA to the second STA when the first STA has changed from the first operating mode to the second operating mode.

7. The first STA of claim 5, wherein based on the class 2 mode class, the operating mode change control frame is transmitted from the second STA to the first STA when the second STA is in the first operating mode, and the mode change response frame is transmitted from the first STA to the second STA when the first STA is in the first operating mode prior to the first STA changing from the first operating mode to the second operating mode.

8. The first STA of claim 5, wherein based on the class 3 mode class, the operating mode change control frame is transmitted from the second STA to the first STA when the second STA is in the second operating mode, and the mode change response frame is transmitted from the first STA to the second STA when the first STA is in the second operating mode after the first STA has changed from the first operating mode to the second operating mode.

9. The first STA of claim 1, wherein the information indicating when the first STA changes from the second operating mode back to the first operating mode comprises a time duration for which the first STA remains in the second operating mode prior to changing back to the first operating mode.

10. The first STA of claim 1, wherein the information indicating when the first STA changes from the second operating mode back to the first operating mode comprises a condition to indicate an end of duration of the second operating mode and a change back to the first operating mode.

11. A method performed by a first station (STA) comprising:
receiving, from a second STA, an operating mode change control frame including information indicating the first STA change from a first operating mode to second operating mode and information indicating when the first STA changes from the second operating mode back to the first operating mode; and
transmitting, to the second STA, a mode change response frame including information indicating status information associated with the information indicating the first STA change from a first operating mode to second operating mode.

12. The method of claim 11, wherein the first STA is a non-access point (non-AP) STA, and the second STA is an AP STA.

13. The method of claim 11, wherein the information indicating the first STA change from a first operating mode to second operating mode comprises a mode type selected from the group consisting of a power saving (PS) mode, a non-primary channel access (NPCA) mode, a dynamic subchannel operating (DSO) mode, a coexistence mode, and a dynamic preamble puncturing mode.

14. The method of claim 11, wherein the information indicating status information comprises a status field selected from the group consisting of:
declined, wherein declined indicates that the first STA declines the change from the first operating mode to the second operating mode;
success, wherein success indicates that the first STA accepts the change from the first operating mode to the second operating mode; and
suggested-parameters, wherein suggested-parameter indicates that the first STA suggests other operating parameters relative to operating parameters received from the second STA in the operating mode change control frame.

15. The method of claim 11, wherein the information indicating the first STA change from a first operating mode to second operating mode comprises a mode class selected from the group consisting of class 1, class 2, and class 3.

16. The method of claim 15, wherein based on the class 1 mode class, the operating mode change control frame is transmitted from the second STA to the first STA when the second STA is in the first operating mode, and the mode change response frame is transmitted from the first STA to the second STA when the first STA has changed from the first operating mode to the second operating mode.

17. The method of claim 15, wherein based on the class 2 mode class, the operating mode change control frame is transmitted from the second STA to the first STA when the second STA is in the first operating mode, and the mode change response frame is transmitted from the first STA to the second STA when the first STA is in the first operating mode prior to the first STA changing from the first operating mode to the second operating mode.

18. The method of claim 15, wherein based on the class 3 mode class, the operating mode change control frame is transmitted from the second STA to the first STA when the second STA is in the second operating mode, and the mode change response frame is transmitted from the first STA to the second STA when the first STA is in the second operating mode after the first STA has changed from the first operating mode to the second operating mode.

19. The method of claim 11, wherein the information indicating when the first STA changes from the second operating mode back to the first operating mode comprises a time duration for which the first STA remains in the second operating mode prior to changing back to the first operating mode.

20. The method of claim 11, wherein the information indicating when the first STA changes from the second operating mode back to the first operating mode comprises a condition to indicate an end of duration of the second operating mode and a change back to the first operating mode.
